(19) United States
(12) Patent Application Publication
(10) Pub. No.: US 2025/0166536 A1
(43) Pub. Date: May 22, 2025

(54) NIGHT MODE FOR XR SYSTEMS

(71) Applicant: Snap Inc., Santa Monica, CA (US)

(72) Inventors: Jian Wang, West New York, NJ (US); Bing Wu, Davie, FL (US)

(21) Appl. No.: 18/951,318

(22) Filed: Nov. 18, 2024

Related U.S. Application Data
(60) Provisional application No. 63/600,698, filed on Nov. 19, 2023.

(51) Int. Cl. G09G 3/00; G06F 3/01

(52) U.S. Cl. CPC G09G 3/001; G06F 3/013; G09G 2340/0407; G09G 2354/00

(57) ABSTRACT

An XR system is disclosed having a night mode to optimize performance in low light conditions. The system estimates a user's dark adaptation level based on captured image data and selects a rendering configuration aligned with the user's vision. For example, spatial resolution, temporal resolution, color mode, and brightness are adjusted based on whether the adaptation level is scotopic, mesopic, or photopic. With eye tracking, foveated rendering is used for cones and periphery rendering for rods. Without eye tracking, modes with different wavelengths and colorization are employed. The night mode aims to maximize information visible on the display, conserve power by only showing what eyes can perceive, and preserve night vision by avoiding over-stimulating rods.

### PRIORITY CLAIM

This application claims the benefit of U.S. Provisional Application No. 63/600,698, filed on Nov. 19, 2023, which is hereby incorporated by reference in its entirety.

### TECHNICAL FIELD

The present disclosure relates generally to extended reality systems, and more particularly, to extended reality system user interfaces.

### BACKGROUND

A head-wearable apparatus may be implemented with a transparent or semi-transparent display through which a user of the head-wearable apparatus can view the surrounding environment. Such head-wearable apparatuses enable a user to see through the transparent or semi-transparent display to view the surrounding real-world environment, and to also see objects (e.g., virtual objects such as a rendering of a two-dimensional (2D) or three-dimensional (3D) graphic model, images, video, text, and so forth) that are generated for display to appear as a part of, and/or overlaid upon, the surrounding environment. This is typically referred to as “augmented reality” or “AR.” A head-wearable apparatus may additionally completely occlude a user's visual field and display a virtual environment through which a user may move or be moved. This is typically referred to as “virtual reality” or “VR.” In a hybrid form, a view of the surrounding environment is captured using cameras, and then that view is displayed along with augmentation to the user on displays that occlude the user's eyes. As used herein, the term extended Reality (XR) refers to AR, VR, and/or any hybrids of these technologies unless the context indicates otherwise.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1A is a perspective view of a head-wearable apparatus, in accordance with some examples.

FIG. 1B is a further perspective view of the head-wearable apparatus of FIG. 1A, in accordance with some examples.

FIG. 2 is a diagrammatic representation of a machine that executes instructions that cause the machine to perform any one or more of the methodologies discussed herein, in accordance with some examples.

FIG. 3 is a diagram of types of adaptation and vision modes, according to some examples.

FIG. 4A is a diagram of a field of view or ring of foveal vision and a field of view or ring of peripheral vision for a user's eyes, according to some examples.

FIG. 4B and FIG. 4C illustrate aspects of a foveated night time mode, according to some examples.

FIG. 5 illustrates a graph of estimated rhodopsin levels for average environment light levels 502 and a graph of estimated dark adaptation levels for average environment light levels 504, according to some examples.

FIG. 6A includes a table of eye response characteristics 602 and FIG. 6B illustrates aspects of a night mode AR content processing method 606, according to some examples.

FIG. 7 is a collaboration diagram of components of an XR system, in accordance with some examples.

FIG. 8 illustrates a night mode method, in accordance with some examples.

FIG. 9 illustrates a physiological dark adaptation estimation method, in accordance with some examples.

FIG. 10 illustrates an eye-tracking-based adaptation estimation method, in accordance with some examples.

FIG. 11 illustrates a behavior-based dark adaptation estimation method, in accordance with some examples.

FIG. 12 illustrates a machine learning model based dark adaptation estimation method, in accordance with some examples.

FIG. 13 illustrates an eye-tracking-based night mode rendering method, in accordance with some examples.

FIG. 14 illustrates a non-eye-tracking based rendering method, in accordance with some examples.

FIG. 15 illustrates a machine-learning pipeline, according to some examples.

FIG. 16 illustrates training and use of a machine-learning program, according to some examples.

FIG. 17 illustrates a system of a head-wearable apparatus, in accordance with some examples.

FIG. 18 is a collaboration diagram of a networked environment, in accordance with some examples.

FIG. 19 is a diagrammatic representation of a data structure as maintained in a database, in accordance with some examples.

FIG. 20 is a diagrammatic representation of a messaging system that has client-side and server-side functionality, in accordance with some examples.

FIG. 21 is a block diagram showing a software architecture, in accordance with some examples.

### DETAILED DESCRIPTION

AR systems allow users to view virtual content overlaid on the real world. A key distinction between AR and VR is that AR allows users to still perceive the real environment, whereas VR fully replaces reality with a virtual environment.

Human vision relies on two types of photoreceptor cells-cones for daytime/bright light viewing, and rods for nighttime/low light viewing. The transition from cone to rod vision is called dark adaptation and takes 1-25 minutes when going from bright light to low light conditions. Exposure to bright light during dark adaptation can disrupt night vision.

Traditional AR systems do not account for the differences in human vision between bright and low light environments. Rendering virtual content optimized for daytime use can impair or break a user's dark adaptation at night, preventing them from simultaneously seeing both virtual and real-world elements.

To address this problem, a night mode feature for XR systems is used to optimize performance in low light conditions. In a night mode, rendering settings are adjusted such as spatial resolution, temporal resolution, color mode, and brightness based on ambient light levels to align with the user's level of dark adaptation. This provides the advantages of maximizing information visible on the display, conserving power by only displaying what the eyes can perceive, and preserving night vision to see the real-world environment. An estimate of the user's current night vision status can be used to further optimize rendering.

In some examples, an XR system captures image data using a camera of an XR system and estimates a dark adaptation level of a user based on the image data. The XR system selects a night mode rendering configuration based on the estimated dark adaptation level and generates an XR display using the selected rendering configuration. Finally, the method displays the XR display to the user.

In some examples, a physiological dark adaptation estimation method is used to estimate the dark adaptation level. The physiological dark adaptation estimation method includes estimating a rod photoreceptor response or analyzing eye tracking data by flickering a low-light signal in an XR system display, and then measuring an Electroencephalogram (EEG) signal captured from a visual cortex of a user. Electroencephalogram/Event-Related Potential (EEG/ERP) signal can tell whether photoreceptors can detect the low-light signal. Selecting the rendering configuration includes choosing peripheral rendering settings and foveal rendering settings. The rendering configuration can include a lower spatial resolution in the peripheral region versus the foveal region and a lower temporal resolution in the peripheral region versus the foveal region. The rendering configuration may also utilize longer wavelength light in the peripheral region versus the foveal region.

In some examples, an eye-tracking-based adaptation estimation method is used to estimate the user's eye dark adaptation level. The eye-tracking-based adaptation estimation method involves flickering a low-light signal in the XR system and capturing eye tracking data of the user's eyes. The method then analyzes the eye tracking data to detect if the user's eyes notice the flickering and estimates the dark adaptation level based on whether the flickering is noticed.

In some examples, a behavior-based dark adaptation estimation method is used to estimate the user's eye dark adaptation level. The behavior-based dark adaptation estimation method includes displaying interaction instructions using low-intensity, low-contrast text in the XR system, with the instructions displayed at varying contrast levels. The method detects the user performing the displayed interaction instructions and estimates the dark adaptation level based on the contrast level of the displayed instructions that the user is able to detect.

In some examples, estimating the user's eye dark adaptation level involves sensing an ambient light of the environment level over a period of time and measuring a pupil size of the user's eyes. The method inputs the ambient light level and pupil size into a machine learning model and estimates the dark adaptation level based on the output of the machine learning model. In some examples, the period of time is in a range of 25 minutes to 35 minutes. In some examples, ground truth for re-training the machine learning model can be obtained using a physiological dark adaptation estimation method, an eye-tracking-based adaptation estimation method, and/or a behavior-based dark adaptation estimation method.

Other technical features may be readily apparent to one skilled in the art from the following figures, descriptions, and claims.

### Head-Wearable Apparatus

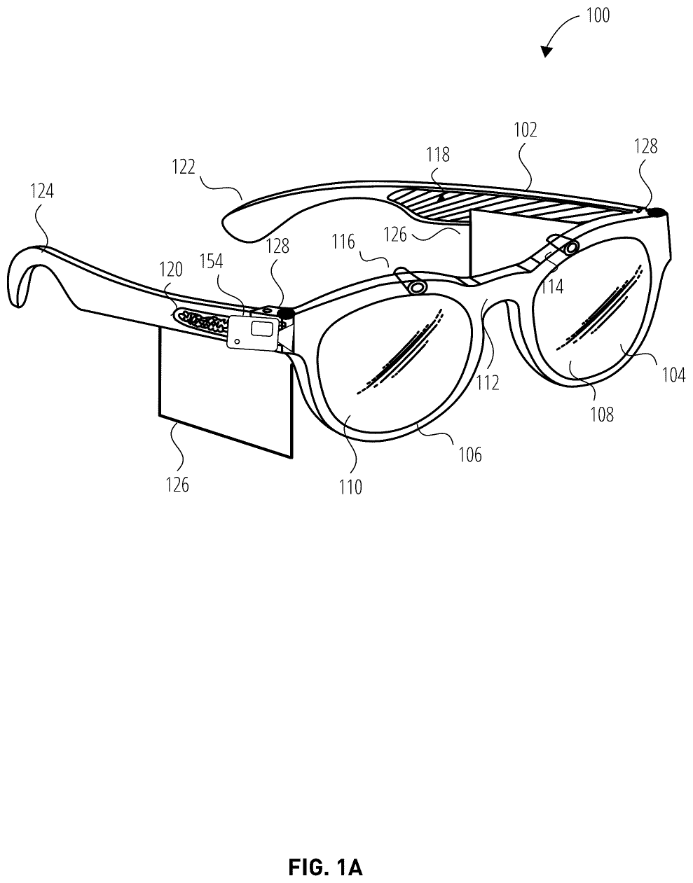

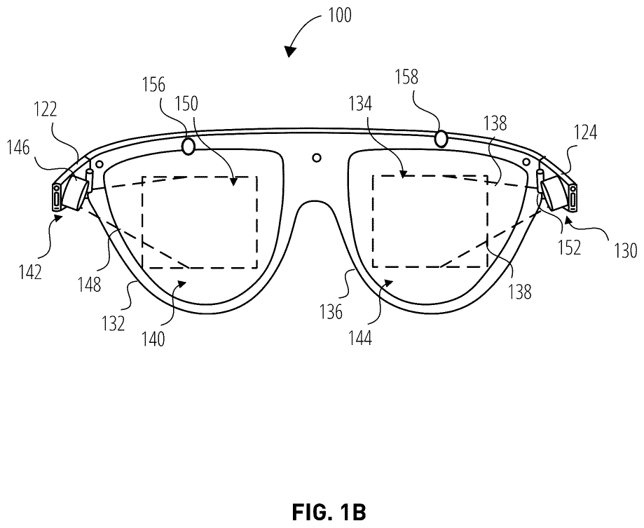

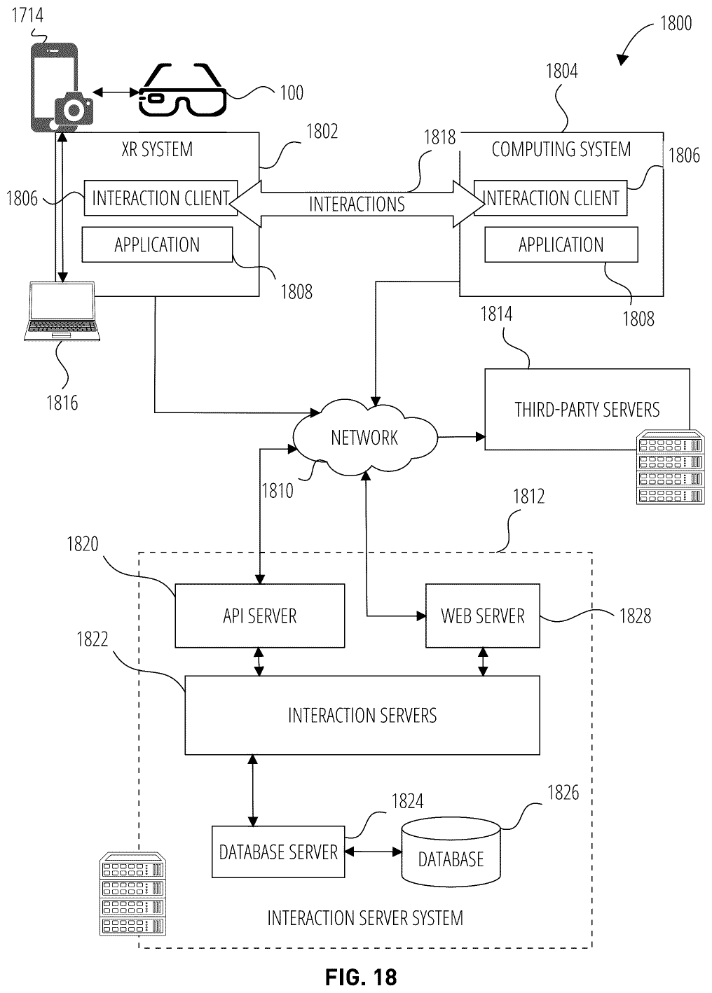

FIG. 1A is a perspective view of an XR user device in a form of a head-wearable apparatus 100, in accordance with some examples. The head-wearable apparatus 100 may be a client device of an XR system, such as XR system 1802 of FIG. 18 or the head-wearable apparatus 100 may be a stand-alone XR system. The head-wearable apparatus 100 can include a frame 102 made from any suitable material such as plastic or metal, including any suitable shape memory alloy. In one or more examples, the frame 102 includes a first or left optical element holder 104 (e.g., a display or lens holder) and a second or right optical element holder 106 connected by a bridge 112. A first or left optical element 108 and a second or right optical element 110 can be provided within respective left optical element holder 104 and right optical element holder 106. The right optical element 110 and the left optical element 108 can be a lens, a display, a display assembly, or a combination of the foregoing. Any suitable display assembly can be provided in the head-wearable apparatus 100.

The frame 102 additionally includes a left arm or left temple piece 122 and a right arm or right temple piece 124. In some examples, the frame 102 can be formed from a single piece of material so as to have a unitary or integral construction.

The head-wearable apparatus 100 can include a computing device, such as a computer 120, which can be of any suitable type so as to be carried by the frame 102 and, in one or more examples, of a suitable size and shape so as to be partially disposed in one of the left temple piece 122 or the right temple piece 124. The computer 120 can include one or more hardware processors with memory, wireless communication circuitry, and a power source. As discussed below, the computer 120 comprises low-power circuitry 1726, high-speed circuitry 1728, and a display processor. Various other examples may include these elements in different configurations or integrated together in different ways. Additional details of aspects of the computer 120 may be implemented as illustrated by the machine 200 discussed herein.

The computer 120 additionally includes a battery 118 or other suitable portable power supply. In some examples, the battery 118 is disposed in left temple piece 122 and is electrically coupled to the computer 120 disposed in the right temple piece 124. The head-wearable apparatus 100 can include a connector or port (not shown) suitable for charging the battery 118, a wireless receiver, transmitter or transceiver (not shown), or a combination of such devices.

The head-wearable apparatus 100 includes a first or left camera 114 and a second or right camera 116. Although two cameras are depicted, other examples contemplate the use of a single or additional (i.e., more than two) cameras.

In some examples, the head-wearable apparatus 100 includes any number of input sensors or other input/output devices in addition to the left camera 114 and the right camera 116. Such sensors or input/output devices can additionally include biometric sensors, location sensors, motion sensors, and so forth. For example, the biometric sensors may include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. Any biometric data collected by the biometric components is captured and stored with only user approval and deleted on user request. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the biometric data is not shared or sold to any third party without the explicit consent of the user. In addition, appropriate technical and organizational measures are implemented to ensure the security and confidentiality of this sensitive information.

In some examples, the head-wearable apparatus 100 comprises one or more sensors, such as sensor 154, that are used to capture data of a real-world scene. In some examples, the one or more sensors comprise one or more scanning sensors having a sensing or image forming component that is moveably coupled to the frame 102. In some examples, the one or more scanning sensors are point scanning sensors such as, but not limited to, LiDAR sensors and the like, that determine a distance or depth of a point on a physical object or surface in the real-world scene. In some examples, the one or more scanning sensors have a fixed FOV such as, but not limited to, scanning cameras and the like, that are used to capture image data of the real-world scene. In some examples, the one or more sensors are fixed sensors that are fixedly coupled to the frame 102, such as right camera 116 and left camera 114, that are not moveable relative to the frame 102.

The position sensors and motion sensors may include acceleration sensor components (e.g., accelerometer), gravitation sensor components, rotation sensor components (e.g., gyroscope), and the like. In some examples, the position sensors and motion sensors may be incorporated in an Inertial Measurement Unit (IMU) or the like.

In some examples, the head-wearable apparatus 100 identifies its position and orientation in three Dimensional (3D) space where the position and orientation taken together constitute a pose of the head-wearable apparatus 100. A pose is comprised of 6 values, 3 values for a position within a 3D Cartesian coordinate system having three orthogonal axis (a horizontal or X axis, a vertical or Y axis, and a depth or Z axis), and 3 values for a rotation around each respective axis (e.g., the Euler angles, such as (α, β, γ), or pitch, yaw, and roll). The 6 values are compactly referred to as the 6 Dimensional (6D) pose of the device. A pose tracking component (not shown) of the head-wearable apparatus 100 may comprise sensors and components such as, but not limited to, the right camera 116, the left camera 114, a Global Positioning System (GPS), an IMU, gravitometers, and the like, whose outputs are combined to track movement, orientation, and position of the head-wearable apparatus 100. The task of determining the pose of the head-wearable apparatus 100 is referred to as pose estimation.

In some examples, the pose tracking component tracks the pose of the head-wearable apparatus 100 based on visual Simultaneous Location And Mapping (vSLAM) methodologies using the outputs of an IMU and one or more cameras of the head-wearable apparatus 100.

During an XR experience, the head-wearable apparatus 100 may continuously estimate its pose in a 3D coordinate system. The position of the head-wearable apparatus 100 is measured by the positional displacement of the head-wearable apparatus 100 from the origin of the 3D coordinate system and the orientation is measured by the angular (rotational) displacement of the axes of the head-wearable apparatus 100 from the axes of the 3D coordinate system. The position is expressed by a set of points, (e.g., cartesian coordinates), such as (x,y,z). The orientation is typically expressed by a set of rotation angles, (e.g., the Euler angles), such as (α, β, γ). Other parameterizations to express the rotational displacement may be used, such as quaternions or angle-axis representations. The pose may be expressed as a transformation matrix or a mapping.

In some examples, the left camera 114 and the right camera 116 provide video frame data for use by the head-wearable apparatus 100 to extract 3D information from a real-world scene including depths or displacements along the Z axis from the head-wearable apparatus 100.

The head-wearable apparatus 100 may also construct and maintain one or more 3D reference frames with each reference frame comprising a respective coordinate system. For example, the head-wearable apparatus 100 may construct a local real-world scene reference frame, a global real-world reference frame, a reference frame associated to the head-wearable apparatus 100, and the like. Each reference frame may be associated with transformations that relate positions and orientations in the different reference systems. As an example, a depth measurement and a direction from the head-wearable apparatus 100 may be transformed into a local coordinate system of a local real-world scene reference frame to identify a location of a corresponding physical object in the real-world scene reference frame and coordinate system.

The head-wearable apparatus 100 may also include a touchpad 126 mounted to or integrated with one or both of the left temple piece 122 and right temple piece 124. The touchpad 126 is generally vertically arranged, approximately parallel to a user's temple in some examples. As used herein, generally vertically aligned means that the touchpad is more vertical than horizontal, although potentially more vertical than that. Additional user input may be provided by one or more buttons 128, which in the illustrated examples are provided on the outer upper edges of the left optical element holder 104 and right optical element holder 106. The one or more touchpads 126 and buttons 128 provide a means whereby the head-wearable apparatus 100 can receive input from a user of the head-wearable apparatus 100.

FIG. 1B illustrates the head-wearable apparatus 100 from the perspective of a user while wearing the head-wearable apparatus 100. For clarity, a number of the elements that are shown in FIG. 1A have been omitted in FIG. 1B. As described in FIG. 1A, the head-wearable apparatus 100 shown in FIG. 1B includes left optical element 140 and right optical element 144 secured within the left optical element holder 132 and the right optical element holder 136 respectively.

The head-wearable apparatus 100 includes right forward optical assembly 130 comprising a left near eye display 150, a right near eye display 134, and a left forward optical assembly 142 including a left projector 146 and a right projector 152.

In some examples, the near eye displays are waveguides. The waveguides include reflective or diffractive structures (e.g., gratings and/or optical elements such as mirrors, lenses, or prisms). Light 138 emitted by the right projector 152 encounters the diffractive structures of the waveguide of the right near eye display 134, which directs the light towards the right eye of a user to provide an image on or in the right optical element 144 that overlays the view of the real-world scene seen by the user. Similarly, light 148 emitted by the left projector 146 encounters the diffractive structures of the waveguide of the left near eye display 150, which directs the light towards the left eye of a user to provide an image on or in the left optical element 140 that overlays the view of the real-world scene seen by the user. The combination of a Graphics Processing Unit (GPU), an image display driver, the right forward optical assembly 130, the left forward optical assembly 142, left optical element 140, and the right optical element 144 provide an optical engine of the head-wearable apparatus 100. The head-wearable apparatus 100 uses the optical engine to generate an overlay of the real-world scene view of the user including display of a user interface to the user of the head-wearable apparatus 100.

It will be appreciated, however, that other display technologies or configurations may be utilized within an optical engine to display an image to a user in the user's field of view. For example, instead of a projector and a waveguide, an LCD, LED or other display panel or surface may be provided.

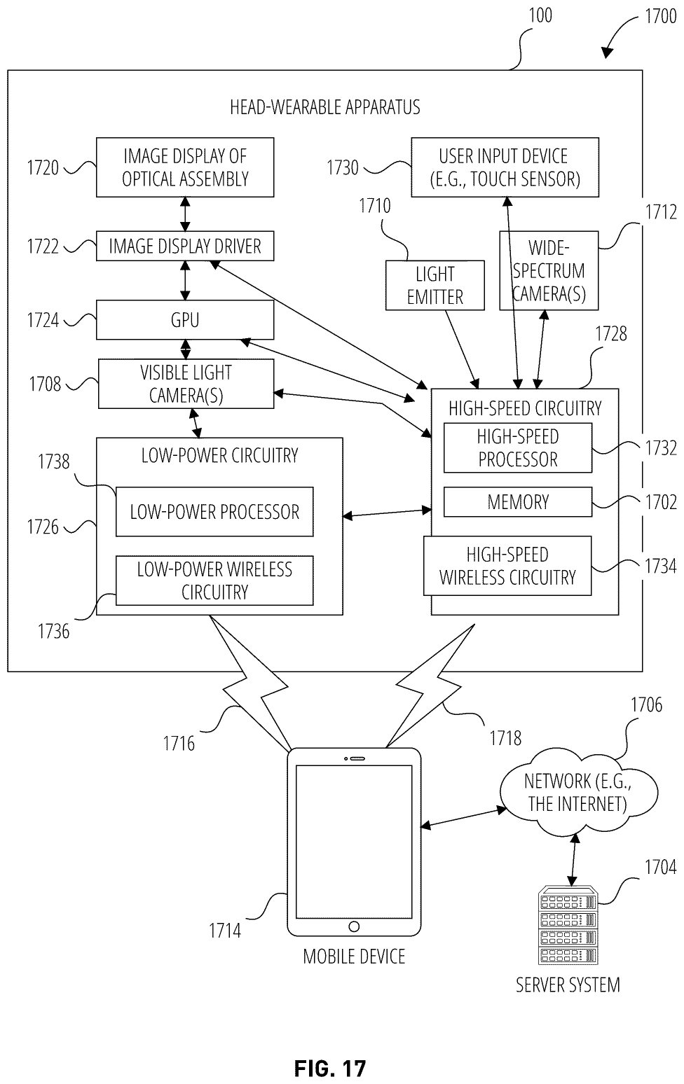

In use, a user of the head-wearable apparatus 100 will be presented with information, content, and various user interfaces on the near eye displays. As described in more detail herein, the user can then interact with the head-wearable apparatus 100 using a touchpad 126 and/or the button 128, voice inputs or touch inputs on an associated device (e.g. mobile device 1714 illustrated in FIG. 17), and/or hand movements, locations, and positions recognized by the head-wearable apparatus 100.

In some examples, an optical engine of an XR system is incorporated into a lens that is in contact with a user's eye, such as a contact lens or the like. The XR system generates images of an XR experience using the contact lens.

In some examples, the head-wearable apparatus 100 comprises one or more eye-tracking sensors, such as eye-tracking sensor 156 and eye-tracking sensor 158, that are operable to capture eye-tracking data of one or more of eyes of a user of the head-wearable apparatus 100.

In some examples, the head-wearable apparatus 100 comprises an XR system. In some examples, the head-wearable apparatus 100 is a component of an XR system including additional computational components. In some examples, the head-wearable apparatus 100 is a component in an XR system comprising additional user input systems or devices.

### Machine Architecture

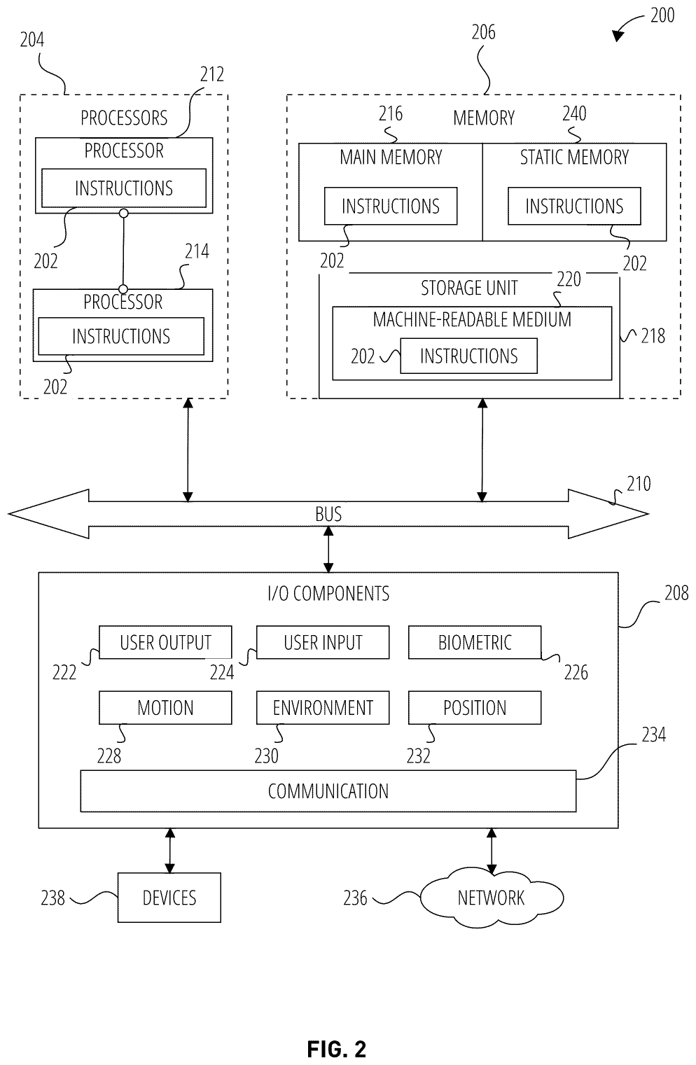

FIG. 2 is a diagrammatic representation of the machine 200 within which instructions 202 (e.g., software, a program, an application, an applet, an app, or other executable code) for causing the machine 200 to perform any one or more of the methodologies of a head-wearable apparatus or mobile device as discussed herein may be executed. For example, the instructions 202 may cause the machine 200 to execute any one or more of the methods described herein. The instructions 202 transform the general, non-programmed machine 200 into a particular machine 200 programmed to carry out the described and illustrated functions in the manner described. The machine 200 may operate as a standalone device or may be coupled (e.g., networked) to other machines. In a networked deployment, the machine 200 may operate in the capacity of a server machine or a client machine in a server-client network environment, or as a peer machine in a peer-to-peer (or distributed) network environment. The machine 200 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 202, sequentially or otherwise, that specify actions to be taken by the machine 200. Further, while a single machine 200 is illustrated, the term “machine” shall also be taken to include a collection of machines that individually or jointly execute the instructions 202 to perform any one or more of the methodologies discussed herein. The machine 200, for example, may comprise the XR system 1802 or any one of multiple server devices forming part of the interaction server system 1812. In some examples, the machine 200 may also comprise both client and server systems, with certain operations of a particular method or algorithm being performed on the server-side and with certain operations of the particular method or algorithm being performed on the client-side.

The machine 200 may include hardware processors 204, memory 206, and input/output I/O components 208, which may be configured to communicate with each other via a bus 210. In an example, the processors 204 (e.g., a Central Processing Unit (CPU), a Reduced Instruction Set Computing (RISC) Processor, a Complex Instruction Set Computing (CISC) Processor, a GPU, a Digital Signal Processor (DSP), an Application Specific Integrated Circuit (ASIC), a Radio-Frequency Integrated Circuit (RFIC), another processor, or any suitable combination thereof) may include, for example, a processor 212 and a processor 214 that execute the instructions 202. The term “processor” is intended to include multi-core processors that may comprise two or more independent processors (sometimes referred to as “cores”) that may execute instructions contemporaneously. Although FIG. 2 shows multiple processors 204, the machine 200 may include a single processor with a single core, a single processor with multiple cores (e.g., a multi-core processor), multiple processors with a single core, multiple processors with multiples cores, or any combination thereof.

The memory 206 includes a main memory 216, a static memory 240, and a storage unit 218, both accessible to the processors 204 via the bus 210. The main memory 206, the static memory 240, and storage unit 218 store the instructions 202 embodying any one or more of the methodologies or functions described herein. The instructions 202 may also reside, completely or partially, within the main memory 216, within the static memory 240, within machine-readable medium 220 within the storage unit 218, within at least one of the processors 204 (e.g., within the processor's cache memory), or any suitable combination thereof, during execution thereof by the machine 200.

The I/O components 208 may include a wide variety of components to receive input, provide output, produce output, transmit information, exchange information, capture measurements, and so on. The specific I/O components 208 that are included in a particular machine will depend on the type of machine. For example, portable machines such as mobile phones may include a touch input device or other such input mechanisms, while a headless server machine will likely not include such a touch input device. It will be appreciated that the I/O components 208 may include many other components that are not shown in FIG. 2. In various examples, the I/O components 208 may include user output components 222 and user input components 224. The user output components 222 may include visual components (e.g., a display such as a plasma display panel (PDP), a Light-Emitting Diode (LED) display, a Liquid Crystal Display (LCD), a projector, or a cathode ray tube (CRT)), acoustic components (e.g., speakers), haptic components (e.g., a vibratory motor, resistance mechanisms), other signal generators, and so forth. The user input components 224 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

The environmental components 230 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), depth or distance sensors (e.g., sensors to determine a distance to an object or a depth in a 3D coordinate system of features of an object), or other components that may provide indications, measurements, or signals corresponding to a surrounding physical environment.

The position components 232 and the motion components 228 include location sensor components (e.g., a GPS receiver component), altitude sensor components (e.g., altimeters or barometers that detect air pressure from which altitude may be derived), orientation sensor components (e.g., magnetometers), and the like. In some examples, the position components 232 and the motion components 228 may be incorporated in an IMU or the like.

The biometric components 226 may include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. Any biometric data collected by the biometric components is captured and stored with only user approval and deleted on user request. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the biometric data is not shared or sold to any third party without the explicit consent of the user. In addition, appropriate technical and organizational measures are implemented to ensure the security and confidentiality of this sensitive information.

With respect to cameras, the machine 200 may have a camera system comprising, for example, front cameras on a front surface of a housing of the machine 200 and rear cameras on a rear surface of the housing of the machine 200. The front cameras may, for example, be used to capture still images and video of a user of the machine (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the XR system 1802 may also include a 360° camera for capturing 360° photographs and videos.

Further, the camera system of the machine 200 may include dual rear cameras (e.g., a primary camera as well as a depth-sensing camera), or even triple, quadruple, or quintuple rear camera configurations on the front and rear sides of the machine 200. These multiple cameras systems may include a wide camera, an ultra-wide camera, a telephoto camera, a macro camera, and a depth sensor, for example.

Communication may be implemented using a wide variety of technologies. The I/O components 208 further include communication components 234 operable to couple the machine 200 to a network 236 or devices 238 via respective coupling or connections. For example, the communication components 234 may include a network interface component or another suitable device to interface with the network 236. In further examples, the communication components 234 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 238 may be another machine or any of a wide variety of peripheral devices (e.g., a peripheral device coupled via a USB).

Moreover, the communication components 234 may detect identifiers or include components operable to detect identifiers. For example, the communication components 234 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 234, such as location via Internet Protocol (IP) geolocation, location via Wi-Fi® signal triangulation, location via detecting an NFC beacon signal that may indicate a particular location, and so forth.

The various memories (e.g., main memory 216, static memory 240, and memory of the processors 204) and storage unit 218 may store one or more sets of instructions and data structures (e.g., software) embodying or used by any one or more of the methodologies or functions described herein. These instructions (e.g., the instructions 202), when executed by processors 204, cause various operations to implement the disclosed examples.

The instructions 202 may be transmitted or received over the network 236, using a transmission medium, via a network interface device (e.g., a network interface component included in the communication components 234) and using any one of several well-known transfer protocols (e.g., hypertext transfer protocol (HTTP)). Similarly, the instructions 202 may be transmitted or received using a transmission medium via a coupling (e.g., a peer-to-peer coupling) to the devices 238.

### Physiological Features of Dark Adaptation

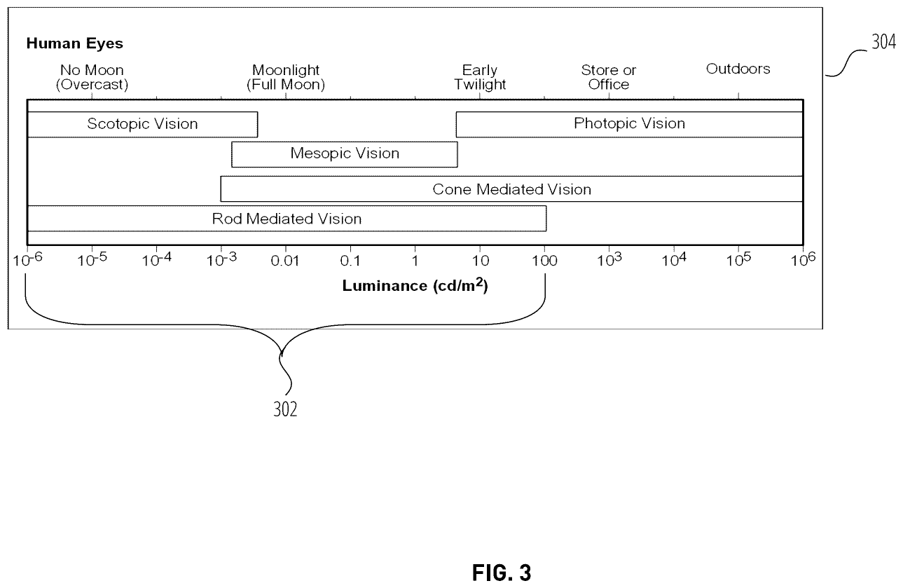

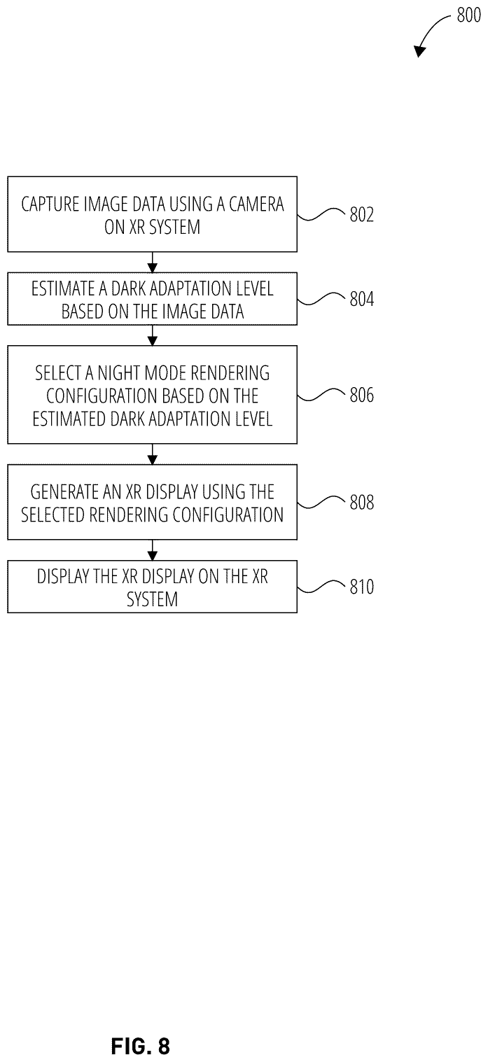

FIG. 3 is a diagram of types of adaptation and vision modes, according to some examples. The diagram of vision modes 304 illustrates three types of vision: scotopic vision, mesopic vision, and photopic vision, versus luminance levels. In some examples, an XR system provides a night mode in a night mode range 302 as more fully described in FIG. 8.

Scotopic vision refers to human vision under low light conditions when only the rod photoreceptors in the retina are actively contributing to sight. Rods are extremely sensitive to light and allow vision in environments with luminance levels as low as 10-6 cd/m². However, scotopic vision lacks color sensitivity, has poor visual acuity, and relies on peripheral vision. It takes around 30 minutes to achieve full dark adaptation for scotopic vision to occur. Scotopic vision allows humans to see under starlight but vision is achromatic (e.g., black-and-white or shades of gray).

Mesopic vision refers to human vision in intermediate lighting conditions when both rod and cone photoreceptors in the retina contribute to sight. It occurs at luminance levels between 0.01 and 3 cd/m² where there is enough light to stimulate some cones but not enough to completely saturate the rods. Mesopic vision allows some color discrimination and better visual acuity than scotopic vision, but sensitivity is lower than full photopic vision. It is a blend of rod-mediated and cone-mediated vision and allows humans to see in environments like moonlight or dim indoor lighting. Visual functions like acuity, color vision, and temporal response are intermediate between scotopic and photopic levels during mesopic vision.

Photopic vision refers to human vision under well-lit conditions when only the cone photoreceptors in the retina are actively contributing to sight. It occurs at luminance levels above 3 cd/m2 which fully saturates the rods. Photopic vision allows for excellent visual acuity, fast flicker response, and color vision mediated by the three types of cones. The cones are concentrated in the fovea and provide high resolution central vision. Photopic vision enables humans to see fine details and color under daylight, indoor lighting, and other bright illumination. Full visual capabilities like reading ability, object recognition, and color perception are achieved in photopic conditions.

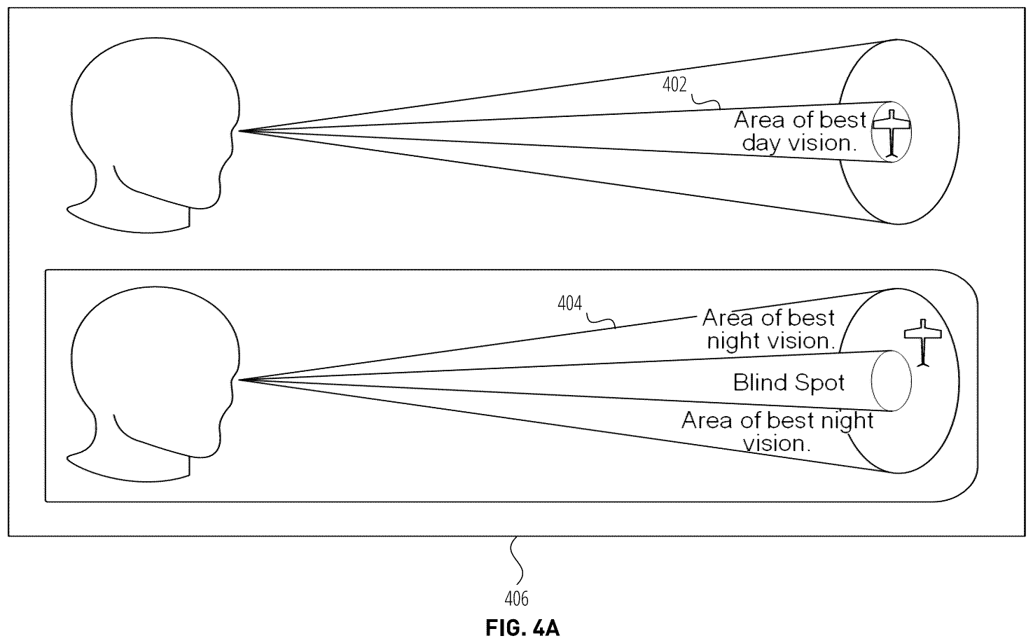

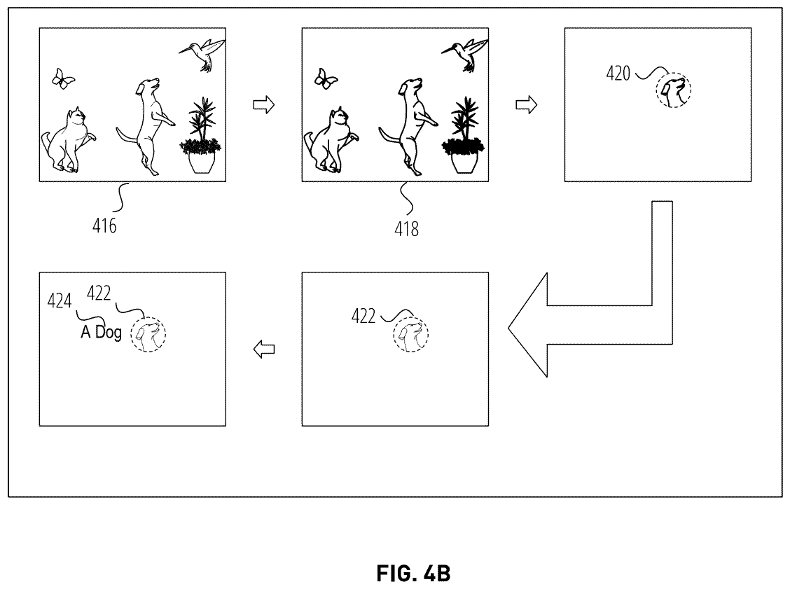

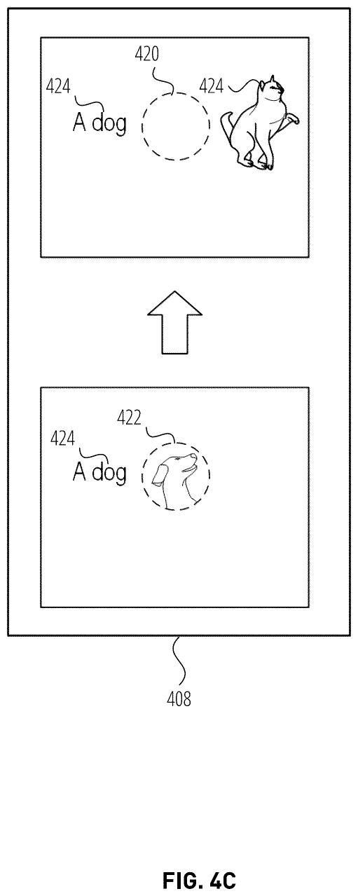

FIG. 4A is a diagram of foveal and peripheral vision 406 of a field of view or ring of foveal vision 402 and a field of view or ring of peripheral vision 404 for a user's eyes, according to some examples. FIG. 4B and FIG. 4C illustrate aspects of a foveated night time mode 408, according to some examples. In some examples, an XR system provides a night mode by providing different content with a user's field of view depending on whether the content is to be displayed in the field of view or ring of foveal vision 402 or the field of view or ring of peripheral vision 404. For example, an original image 416 can be captured of a real-world scene. The image is displayed to a user as a displayed image 418 using a red wavelength of light (e.g., 640 nm) so that the night vision of the rods of the user's eyes are persevered. When gaze tracking, such as eye tracking is used, the displayed image 418 can be the foveated region comprised of a 5 deg field of view of the user's foveated region 420. By doing so, the rods' night vision is preserved and more energy is saved because of the smaller display region and less energy is required for processing. RGB content 422 can be shown in the foveated region of the user's vision without disturbing the rods' night vision. In addition, the RGB content has more information that a monochromatic image. In some examples, green light (e.g., light having a wavelength of 498 nm), can be used to display content 424. In some examples, 498 nm is chosen as using that wavelength for content display provides the most energy savings. In some examples, for content only shown to rods, the retinal location is in the range of 15 degrees to 20 degrees from the gaze direction where the density of the rods reaches a maximum. Spatial resolution and temporal resolution can be much lower than what is needed for day vision, and the spatial resolution can be adaptively reduced towards periphery.

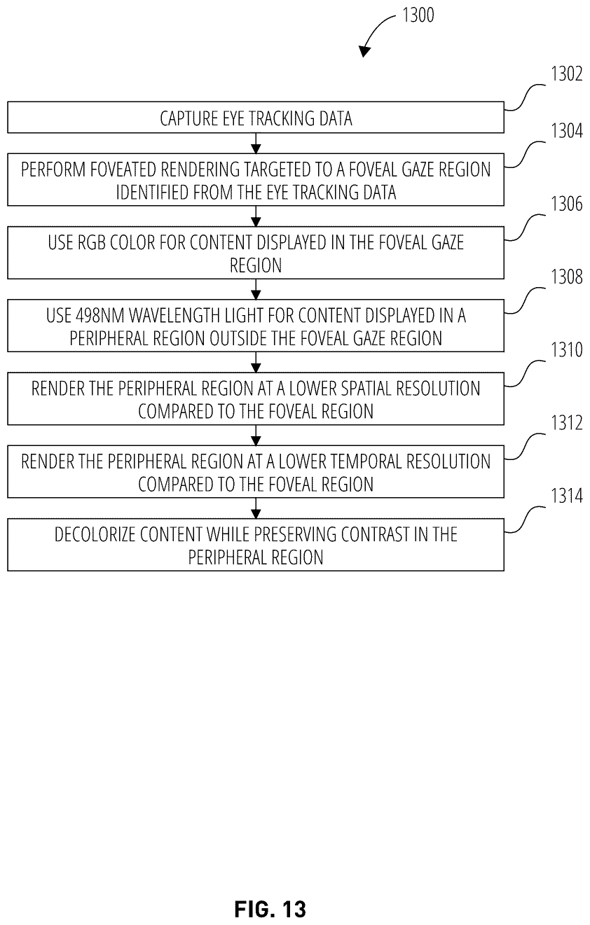

The foveated night time mode 408 is more fully described in reference to FIG. 13.

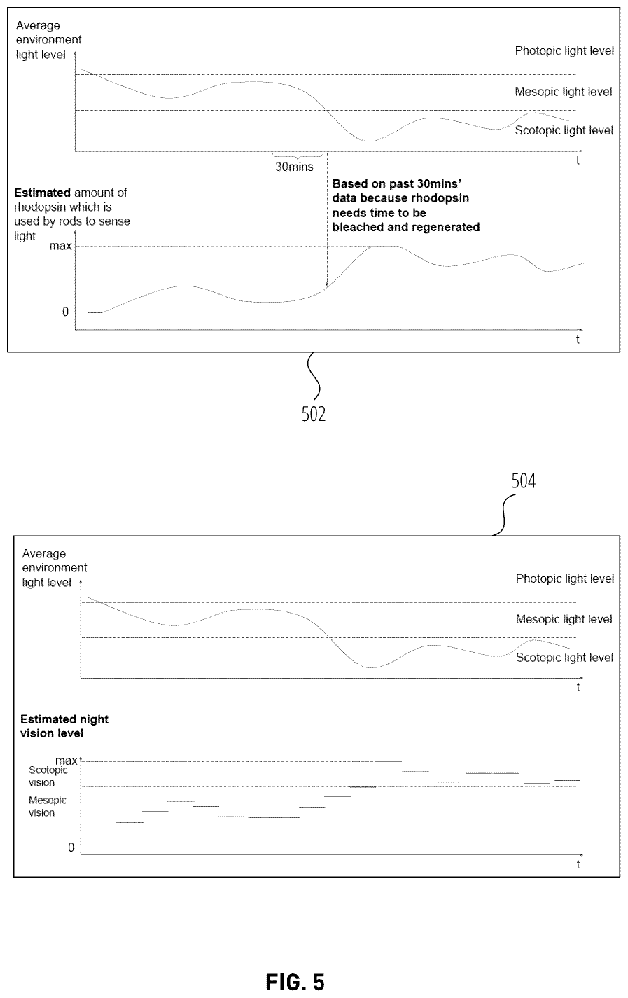

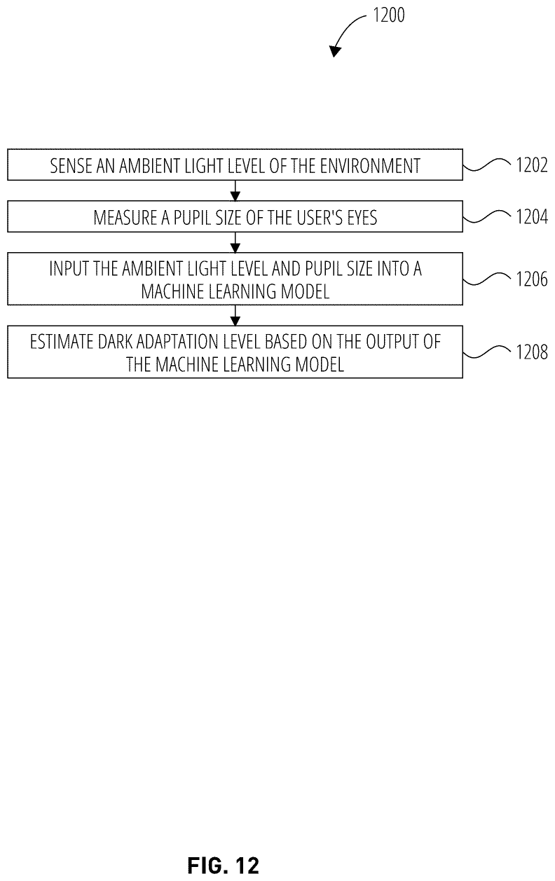

FIG. 5 includes a graph of estimated rhodopsin levels for average environment light levels 502 and a graph of estimated dark adaptation levels for average environment light levels 504, according to some examples. In some examples, an XR system provides a night mode in part by estimating a dark adaptation level of a user's eyes as more fully described in reference to FIG. 12.

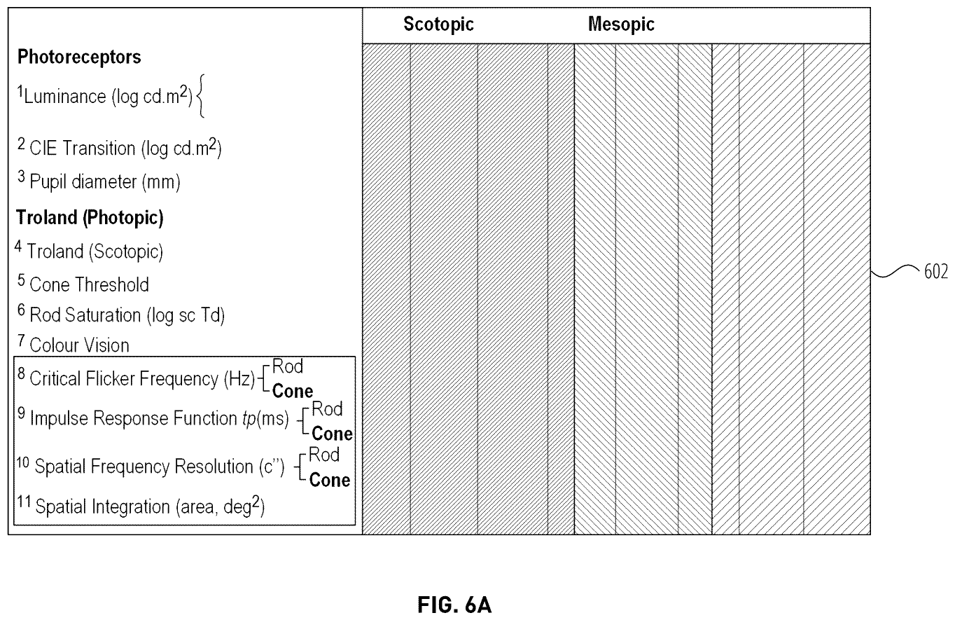

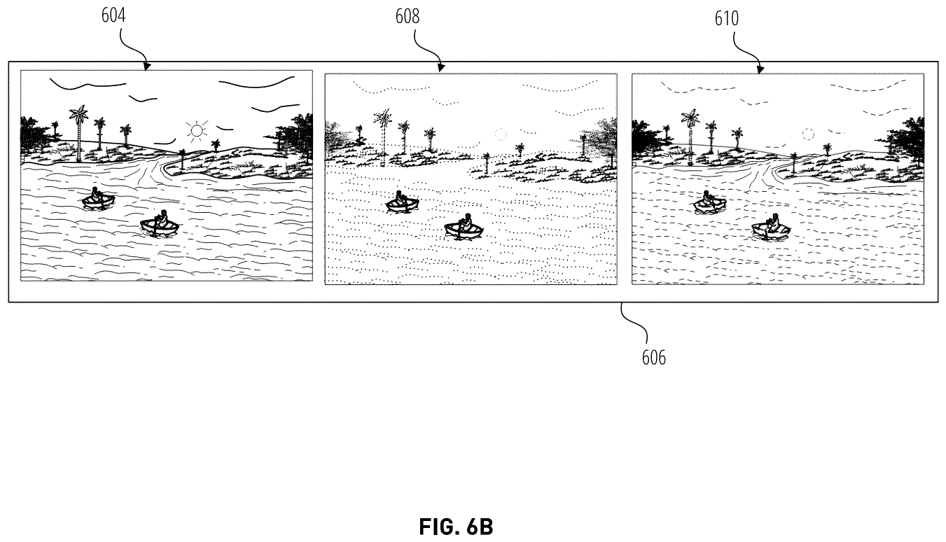

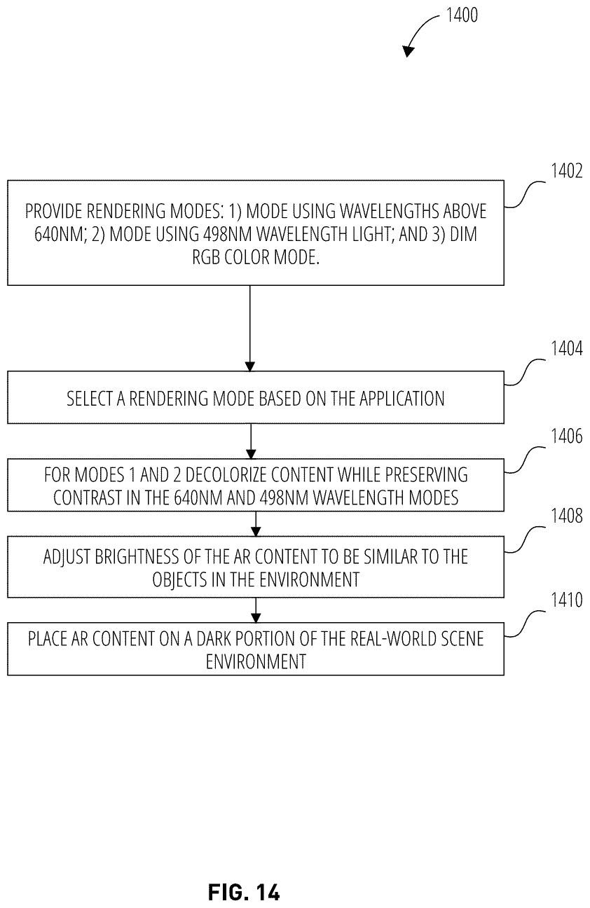

FIG. 6A includes a table of eye response characteristics 602 and FIG. 6B illustrates aspects of a night mode AR content processing method 606, according to some examples. An XR system provides a night mode based in part on the physiological characteristics of a dark adapted user's eye. In the night mode AR content processing method 606, input content 604 is decolorized while preserving contrast 610 as opposed to merely performing a naïve decolorization 608 as more fully described in reference to FIG. 14.

### Night Mode

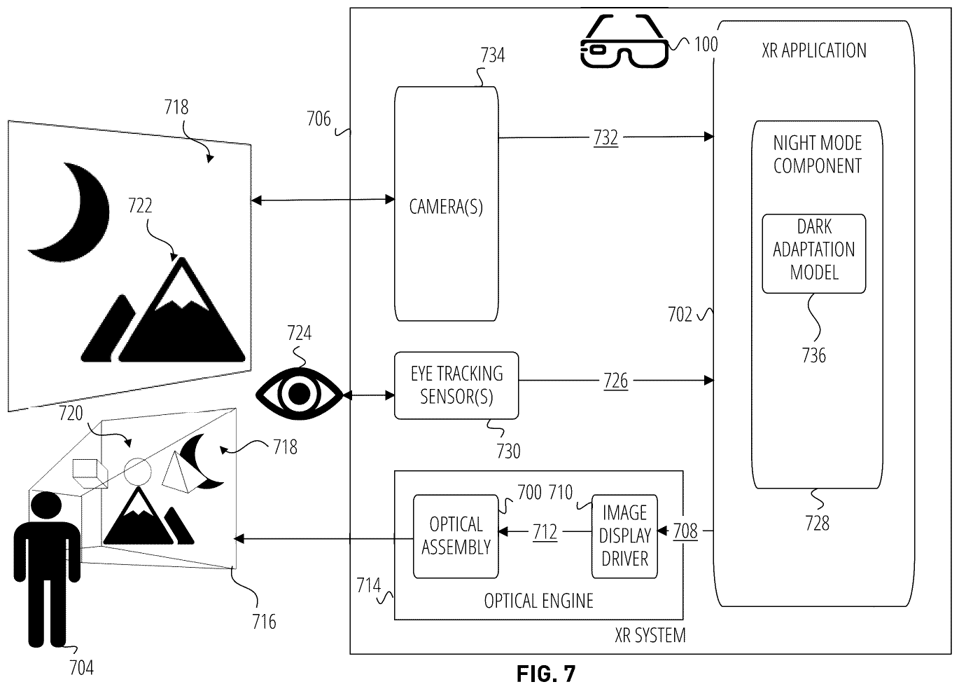

FIG. 7 is a collaboration diagram of components of an XR system 706 having a night mode, and FIG. 8 is a process flow diagram of a night mode method 800 of the XR system 706, in accordance with some examples.

Although the night mode method 800 depicts a particular sequence of operations, the sequence of operations may be altered without departing from the scope of the present disclosure. For example, some of the operations depicted may be performed in parallel, in a different sequence, or by different components of an XR system, without materially affecting the function of the method.

The night mode method 800 is used by the XR system 706 to provide an XR user interface 716 to a user 704. The XR system 706 comprises an XR user device such as, but not limited to, a head-wearable apparatus 100 or the like. The XR system 706 provides an XR user interface 716 to the user 704 using the XR user device. The XR user interface 716 is generated by an XR application 702 of the XR system 706 that uses the services of the night mode component 728 to provide a night mode for an XR experience of a real-world scene 718 including one or more physical objects 722. The XR application 702 may be a useful application such as an interactive game, maintenance guide, an interactive map, an interactive tour guide, a tutorial, or the like. The XR application 702 may also be an entertainment application such as a video game, an interactive video, or the like.

The physical objects 722 may include objects in the real-world scene 718 as well as one or more portions of the body of the user 704 such as, but not limited to, the hands of the user and the like.

To optimize rendering for night mode, a night mode component 728 prioritizes maximizing an amount of information from visible content on a display of the XR system 706 when displaying an XR user interface 716 to a user 704. The night mode component 728 can achieve this by using RGB images rather than grayscale, as RGB conveys more information.

In some examples, the night mode component 728 conserves energy by computing and displaying what the eyes can actually perceive. For computing, the night mode component 728 renders what the eyes will be able to see based on their adaptation level. For displaying, the night mode component 728 adjusts brightness based on the increased sensitivity of cones and rods in low light. The night mode component 728 can also display content for rods using 498 nm light, where they are most sensitive, to further reduce required energy versus other wavelengths.

In some examples, the night mode component 728 preserves night vision to enable users to see their surroundings. The night mode component 728 avoids illuminating rods with content not meant for them. Overall, the night mode component 728 attempts to adjust a brightness of AR content to match the environment of the real-world scene 718.

In some examples, AR content exceeds environmental brightness so it remains visible during adaptation. The night mode component 728 analyzes the real-world scene 718 to avoid overlaying content onto environmental objects, which would increase total brightness.

In some examples, with gaze tracking, the night mode component 728 uses at least one eye-tracking sensor 730 to perform foveated rendering for cones and periphery rendering for rods. The night mode component 728 uses RGB for cones and 498 nm light for rods. The peripheral rendering has lower spatial resolution (1/4 to 1/8 of foveal) and lower frame rate (1/2 to 1/3 of foveal). Resolution decreases further towards the periphery as rod density declines. The night mode component 728 decolorizes peripheral content while retaining contrast.

In some examples, without gaze tracking, the night mode component 728, provides a plurality of rendering modes such as, but not limited to, all red above 640 nm, all 498 nm light, or dim RGB. The choice depends on the application and whether disrupting rods' night vision is acceptable.

In operation 802, the night mode component 728 captures image data 732 using at least one camera 734 of the XR system 706. For example, the night mode component 728 captures image data 732 of the real-world scene by controlling at least one camera 734 of the XR system 706. The night mode component 728 may directly access the camera hardware and capture image frames. Alternatively, the night mode component 728 may invoke operating system APIs and libraries to control the camera 734 and obtain the image data 732. The night mode component 728 could also leverage vision libraries and frameworks to preprocess the image data, by performing operations like image enhancement, compression, resizing, and format conversion.

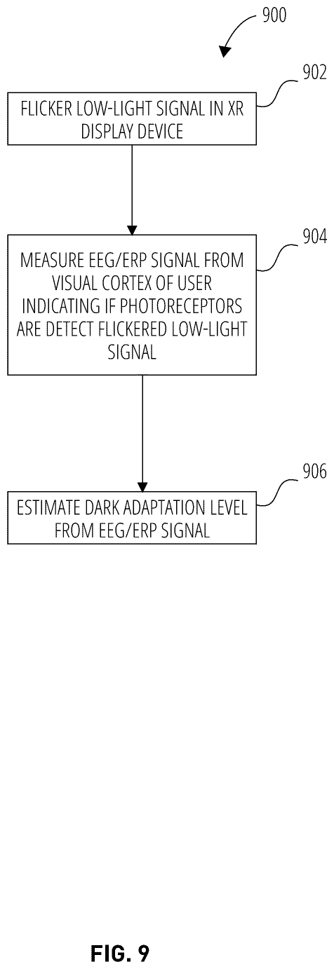

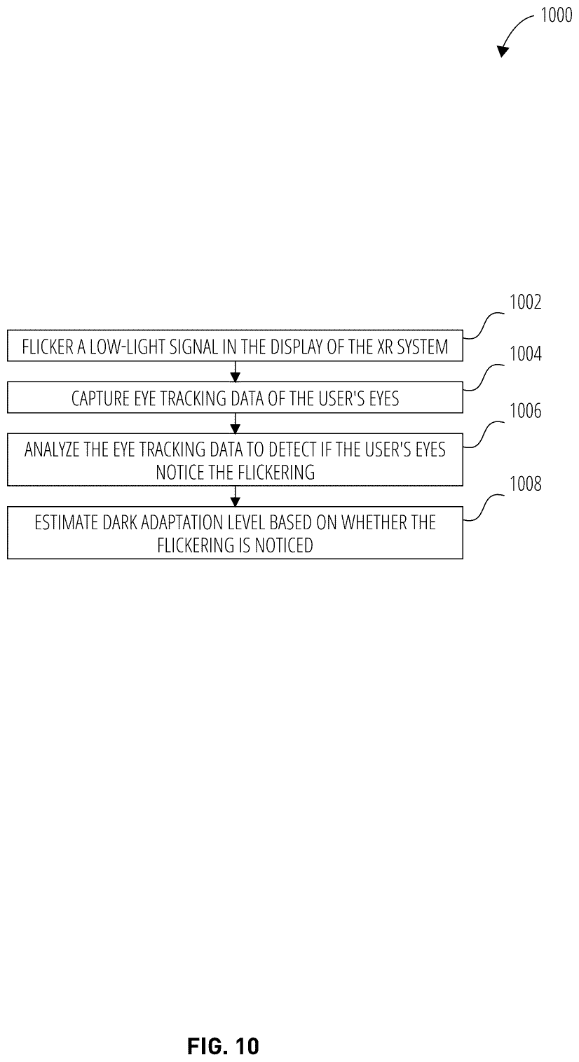

In operation 804, the night mode component 728 estimates a dark adaptation level based on the image data. For example, the night mode component 728 estimates the user's eye dark adaptation level based on analysis of the image data captured in operation 802. In some examples, the night mode component 728 processes the image data to determine ambient light levels and other environmental conditions. In some examples, the night mode component 728 utilizes computer vision techniques and eye-tracking data 726 captured using at least one eye-tracking sensor 730 to detect the user's pupil size from the eye-tracking data 726 as more fully described in reference to FIG. 12. In some examples, the night mode component 728 additionally leverages physiological data collected from the user 704 as more fully described in reference to FIG. 9. In some examples, the night mode component 728 estimates a dark adaptation level using a user stimulus and recorded user reactions as more fully described in reference to FIG. 10.

In operation 806, the night mode component 728 selects a night mode rendering configuration based on the estimated dark adaptation level. For example the night mode component 728 selects an appropriate night mode rendering configuration for the XR display based on the estimated dark adaptation level from operation 804. In some examples, the night mode component 728 selects the eye-tracking-based night mode rendering method 1300 a more fully described in reference to FIG. 13 to select rendering settings like resolution, frame rate, and color mode for foveal versus peripheral regions. In some examples, the night mode component 728 selects the non-eye-tracking based rendering method 1400 more fully described in reference to FIG. 14 to choose between different rendering modes such as all red, 498 nm, or dim RGB.

In operation 808, the night mode component 728 generates an XR user interface 716 of the XR application 702 using the selected rendering configuration. For example, the night mode component 728 actively generates the XR user interface 716 of the XR application 702 using the night mode rendering configuration selected in operation 806. In some examples, the night mode component 728 utilizes graphics APIs and rendering engines to generate the visual content of the XR user interface 716 based on the selected configuration. The night mode component 728 leverages methods like the eye-tracking-based rendering approach in FIG. 13 and the non-eye-tracking rendering approach in FIG. 14 to render the XR user interface 716. In some examples, the night mode component 728 performs foveated rendering for the gaze region and peripheral rendering for outside areas. In some examples, the night mode component 728 selects between different color and brightness modes based on the application before performing the rendering.

In operation 810, the night mode component 728 displays the XR user interface 716 on a display of the XR system 706. For example, the night mode component 728 first generates XR user interface graphics data 708 representing the visual content of the XR user interface 716. The night mode component 728 uses GPU APIs and graphics engines to render the XR user interface graphics data 708 based on the XR user interface 716 generated in operation 808. Next, the night mode component 728 sends the XR user interface graphics data 708 to an image display driver 710 of an optical engine 714. The image display driver 710 then generates display control signals 712 to control the optical assembly 700. The optical assembly 700, under direction of the display control signals 712, displays the visual content of an XR user interface 716 including one or more virtual objects 720 of the XR user interface 716.

FIG. 9 illustrates an example physiological dark adaptation estimation method 900 used by the night mode component 728 of FIG. 7. Although the example physiological dark adaptation estimation method 900 depicts a particular sequence of operations, the sequence may be altered without departing from the scope of the present disclosure. For example, some of the operations depicted may be performed in parallel or in a different sequence that does not materially affect the function of the physiological dark adaptation estimation method 900. In other examples, different components of an example device or system that implements the physiological dark adaptation estimation method 900 may perform functions at substantially the same time or in a specific sequence.

In operation 902, the night mode component 728 flickers a low-light signal in an XR display device of the XR system 706 of FIG. 7. For example, the night mode component 728 actively flickers a low-light signal in an XR display device of the XR system 706 shown in FIG. 7. The night mode component 728 controls the optical assembly and display driver of the XR system 706 to modulate the brightness of the XR display in a flickering pattern using a low-light signal. In some examples, the night mode component 728 generates a plurality of low-light signals that are flickered at one or more frequencies in order to determine at what light intensities and flicker frequencies the user 704 begins to see the display of the low-light signal.

In operation 904, the night mode component 728 measures an Electroencephalogram/Event-Related Potential (EEG/ERP) signal of a visual cortex of a user using the XR system 706. The EEG/ERP signal indicates if photoreceptors detected the low-light signal. For example, the night mode component 728 actively measures an EEG/ERP signal of a visual cortex of a user using an EEG sensor (not shown) of the XR system 706. After flickering the low-light signal in operation 902, the night mode component 728 leverages EEG sensors to detect electrical activity in the visual cortex area of the user's brain. The EEG/ERP signal indicates whether the user's photoreceptors detected the low-light signal that was flickered by the night mode component 728. By actively measuring this brain activity signal, the night mode component 728 can determine if the low-light signal was perceived by the user 704.

In operation 906, the night mode component 728 method estimates dark adaptation level using the EEG/ERP signal. For example, the night mode component 728 analyzes the EEG/ERP signal data to determine if the user's photoreceptors detected the low-light signal that was flickered. Based on this analysis, the night mode component 728 estimates the current dark adaptation level of the user's eyes. For example, if the EEG/ERP signal indicates the low-light flicker was detected, the night mode component 728 estimates the eyes have achieved a target level of dark adaptation. Conversely, if the signal indicates the flicker was not perceived, a lower level of dark adaptation is estimated.

FIG. 10 illustrates an example eye-tracking-based adaptation estimation method 1000 used by the night mode component 728 of FIG. 7. Although the example eye-tracking-based adaptation estimation method 1000 depicts a particular sequence of operations, the sequence may be altered without departing from the scope of the present disclosure. For example, some of the operations depicted may be performed in parallel or in a different sequence that does not materially affect the function of the eye-tracking-based adaptation estimation method 1000. In other examples, different components of an example device or system that implements the eye-tracking-based adaptation estimation method 1000 may perform functions at substantially the same time or in a specific sequence.

In operation 1002, the night mode component 728 of FIG. 7 flickers a low-light signal in an XR display of the XR system 706 of FIG. 7. For example, the night mode component 728 controls the image display driver 710 and optical assembly 700 of the XR system 706 to modulate the brightness of the XR display in a flickering pattern using a low-light signal. This flickering of the low-light signal is performed by the night mode component 728 as part of estimating the user's dark adaptation level based on eye tracking. By flickering the low-light signal in the XR display, the night mode component 728 provides a visual stimulus to the user's eyes to determine if it can be perceived.

In operation 1004, the night mode component 728 captures eye-tracking data 726 of the of at least one eye 724 of the user 704 using at least one eye-tracking sensor 730. For example, the eye-tracking sensor 730 actively tracks the gaze direction and movements of the user's eye 724 to generate eye tracking data 726. This is done in response to the low-light signal that was flickered in the XR display by the night mode component 728 in operation 1002. By tracking the eye 724, the eye-tracking sensor 730 can detect if the user's gaze changes in response to perceiving the flickering of the low-light signal. The eye-tracking data 726 generated by the eye-tracking sensor 730 provides a detection of whether the user 704 noticed the low-light flickering stimulus.

In operation 1006, the night mode component 728 analyzes the eye-tracking data 726 to detect if at least one eye 724 of the user 704 notices the flickering low-light signal. For example, the night mode component 728 examines the gaze patterns and movements contained in the eye tracking data 726. It looks for changes that indicate the user's eye 724 reacted to the flickering stimulus provided in operation 1002. For example, rapid shifts in gaze direction could signify that the user 704 perceived the flickering. By thoroughly analyzing the eye tracking data 726, the night mode component 728 can determine if the low-light flicker was noticed by the user's eyes.

In operation 1008, the night mode component 728 estimates a dark adaptation level based on at least one eye 724 of the user 704 based on whether the flickering is noticed. For example, the night mode component 728 makes this estimation based on the analysis done in operation 1006 of whether the user's eye 724 noticed the low-light flickering stimulus. If the analysis determines that the flickering was noticed by the eye 724, then the night mode component 728 estimates that the eye 724 has achieved a higher level of dark adaptation. This is because the photoreceptors of the eye were able to detect the low-light signal. Conversely, if the analysis in 1006 found that the flickering was not noticed, then the night mode component 728 estimates that the eye 724 has a lower level of dark adaptation. By leveraging the eye tracking analysis, the night mode component 728 determines the current dark adaptation level of the user's eyes.

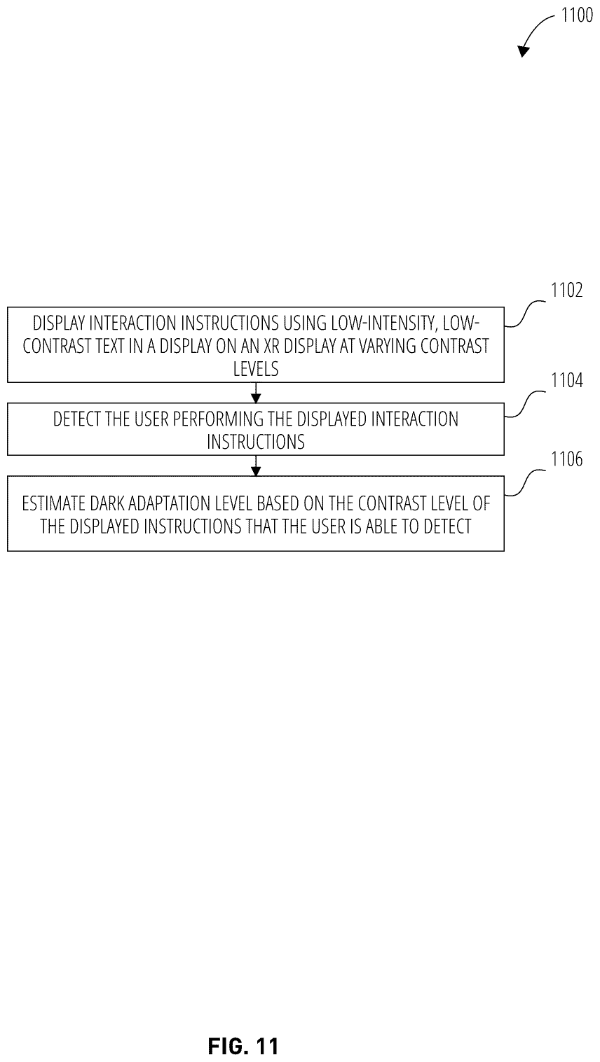

FIG. 11 illustrates an example behavior-based dark adaptation estimation method 1100 used by the night mode component 728 of FIG. 7. Although the example behavior-based dark adaptation estimation method 1100 depicts a particular sequence of operations, the sequence may be altered without departing from the scope of the present disclosure. For example, some of the operations depicted may be performed in parallel or in a different sequence that does not materially affect the function of the behavior-based dark adaptation estimation method 1100. In other examples, different components of an example device or system that implements the behavior-based dark adaptation estimation method 1100 may perform functions at substantially the same time or in a specific sequence.

In operation 1102, the night mode component 728 displays interaction instructions using low-intensity, low-contrast text in a display of the XR system 706 of FIG. 7. The night mode component 728 displays the interaction instructions at varying contrast levels. For example, the night mode component 728 controls the display driver and optical assembly of the XR system 706 to render text prompts that guide the user to perform specific actions. The text is displayed at varying contrast levels, ranging from high to low contrasts. As the user's eyes progressively adapt to the dark over time, more in visible low-contrast text will become visible. By leveraging this effect and displaying instructions with incrementally lower contrast, the night mode component 728 can determine when certain contrast levels become detectable. This allows estimating the current level of dark adaptation. The use of interactive instructions enables a behavior-based approach to estimating the dark adaptation level. In some examples, the night mode component 728 instructs the user 704 to make specific gestures with their hands such as, but not limited to, a thumbs up sign if they can see the instructions.

In operation 1104, the night mode component 728 detects the user performing the displayed interaction instructions. For example, as the user's eyes dark adapt over time and the low-contrast text prompts become more visible, the user will be able to follow the instructions and perform the specified actions. The night mode component 728 utilizes sensors and input devices of the XR system 706 to detect the user's actions. For example, cameras can visually detect hand gestures, while inertial sensors can detect head movements. By leveraging various sensors and inputs, the night mode component 728 is able to detect when the user performs a prompted instruction, signifying the prompted instructions has become visible to the user 704. Detecting which instructions the user can perceive allows estimating the level of dark adaptation.

In operation 1106, the night mode component 728 estimates the user's eye dark adaptation level based on the contrast level of the displayed instructions that the user is able to detect.

FIG. 12 illustrates an example machine learning model based dark adaption estimation method 1200 used by the night mode component 728 of FIG. 7. Although the example machine learning model based dark adaption estimation method 1200 depicts a particular sequence of operations, the sequence may be altered without departing from the scope of the present disclosure. For example, some of the operations depicted may be performed in parallel or in a different sequence that does not materially affect the function of the machine learning model based dark adaptation estimation method 1200. In other examples, different components of an example device or system that implements the machine learning model based dark adaptation estimation method 1200 may perform functions at substantially the same time or in a specific sequence.

In operation 1202, the night mode component 728 senses an ambient light level of the environment. For example, the night mode component 728 utilizes a light sensor, such as a photodiode, photoresistor, or one or more camera pixels, to measure the ambient light intensity around the user. This provides an objective estimate of the overall lighting conditions the user's eyes are adapted to. The sensor converts photons into an electrical signal representing the environmental luminance. Lower light levels indicate a scotopic or mesopic adaptation environment. By quantifying the ambient light, the night mode component 728 gathers useful data for estimating the dark adaptation level in conjunction with other physiological measurements.

In operation 1204, the night mode component 728 measures a pupil size of the user's eyes. For example, the night mode component 728 utilizes at least one eye tracking sensor 730 to determine the pupil size of the user's eye. As the eye adapts to lower light levels, the pupil dilates to allow more light to reach the retina. By measuring the pupil diameter, the night mode component 728 can estimate the level of adaptation. Larger pupil size correlates with a more dilated eye adapted to low light. Along with the ambient light level, pupil size provides another data point for estimating the dark adaptation level using a machine learning model.

In operation 1206, the night mode component 728 inputs the ambient light level over a period of time and pupil size into a machine learning model. For example, the night mode component 728 feeds the light level data from operation 1202 and the pupil size data from operation 1204 into a machine learning model such as dark adaptation model 736 of FIG. 7. The machine learning model has been previously trained on labeled data pairs of light levels, pupil sizes, and corresponding dark adaptation levels. By inputting the current measurements as a feature vector, the model can estimate the user's current dark adaptation level based on its learned correlations. For example, a low light level over a period of time such as, but not limited to, 10 minutes and large pupils would map to a high dark adaptation level. The machine learning approach allows accurately inferring the non-linear relationship between the signals and adaptation level.

In some examples, the period of time is in a range of 25 to 35 minutes.

In some examples, the night mode component 728 collects real-time dark adaptation level data and continuously re-trains the dark adaptation model 736 in real time using the dark adaptation level data. For example, the night mode component 728 uses a method such as, but not limited to, the physiological dark adaptation estimation method 900 of FIG. 9, an eye-tracking-based adaptation estimation method 1000 of FIG. 10, and the like, to collect the dark adaptation level data.

In operation 1208, the night mode component 728 estimates the user's eye dark adaptation level based on the output of the machine learning model. For example, after inputting the light level and pupil size data into the trained machine learning model in operation 1206, the model outputs a predicted dark adaptation level. This could be a continuous value representing the estimated adaptation level, or a discrete classification such as “low,” “medium,” or “high.” The night mode component 728 takes this model output and uses it as the current estimate of the user's level of dark adaptation. This data can then be used to optimize the rendering and display configurations to match what the user's eyes can perceive in their state of adaptation. The machine learning approach provides a data-driven estimate of dark adaptation level.

FIG. 13 illustrates an example eye-tracking-based night mode rendering method 1300 used by the night mode component 728 of FIG. 7. Although the example eye-tracking-based night mode rendering method 1300 depicts a particular sequence of operations, the sequence may be altered without departing from the scope of the present disclosure. For example, some of the operations depicted may be performed in parallel or in a different sequence that does not materially affect the function of the eye-tracking-based night mode rendering method 1300. In other examples, different components of an example device or system that implements the eye-tracking-based night mode rendering method 1300 may perform functions at substantially the same time or in a specific sequence.

In operation 1302, the night mode component 728 captures eye tracking data. For example, the night mode component 728 utilizes at least one eye tracking sensor 730 to track the gaze direction and focus point of the user's eyes. The eye-tracking data 726 of FIG. 7 may include the coordinates of the user's gaze point with respect to the display, as well as measurements of pupil size and eye movements. By continuously capturing this data in real-time, the night mode component 728 can identify which region of the display the user is looking at—either the foveal or peripheral region. The eye tracking data allows optimizing the rendering based on which area will be viewed by the cones versus rods. This enables preserving night vision in the peripheral area while showing detailed content only in the foveal gaze area.

In operation 1304, the night mode component 728 performs foveated rendering targeted to a foveal gaze region identified from the eye tracking data. For example, using the gaze direction and coordinates obtained from the eye tracking sensors, the night mode component 728 identifies the user's foveal gaze region. This is the central region of focus. The night mode component 728 then performs foveated rendering, which renders the content in the foveal gaze region at full resolution, while decreasing the resolution of content in the peripheral region outside the foveal area. This allows concentrating the display processing power to render high resolution content only where the user is looking directly. Content outside the foveal gaze area can be rendered at lower resolution to conserve processing power, since the peripheral rods and cones cannot perceive fine details. The eye tracking data enables isolating the foveal region for high fidelity rendering.

In operation 1306, the night mode component 728 uses RGB color for content displayed in the foveal gaze region. For example, based on the foveal region identified from the eye tracking data in operation 1304, the night mode component 728 renders content in full RGB color in this area. This provides the highest color fidelity, allowing the cones concentrated in the fovea to perceive the full color spectrum. The night mode component 728 leverages the fact that cones are concentrated in the foveal center, while rods dominate in the periphery. By restricting RGB colors only to the foveal gaze region, the night mode component 728 can display colorful content to the cones while avoiding illuminating the peripheral rods with colors that could disrupt their dark adaptation. This approach optimizes information content for cones while protecting rod night vision.

In operation 1308, the night mode component 728 uses 498 nm wavelength light for content displayed in a peripheral region outside the foveal gaze region. For example, based on identifying the peripheral region from the eye tracking data, the night mode component 728 displays content in this area using light centered at a 498 nm wavelength. This wavelength corresponds to the peak light sensitivity of rod photoreceptors, which are concentrated in the peripheral region. Using 498 nm light allows the display to leverage the rod's heightened sensitivity at this wavelength, meaning less light energy is required compared to other wavelengths. This helps conserve power.

In operation 1310, the night mode component 728 renders the peripheral region at a lower spatial resolution compared to the foveal region. For example, based on the peripheral area identified from the eye tracking data, the night mode component 728 displays content in this region at a reduced spatial resolution compared to the foveal gaze area. This is because rod photoreceptors in the periphery provide lower visual acuity than cones concentrated in the fovea. By lowering the spatial resolution of the peripheral content, less processing power is required while still providing an image the rods can perceive. The degree of reduced resolution can be tailored based on the estimated level of scotopic adaptation. In some examples, the peripheral resolution may be 1/4 to 1/8 the foveal resolution. And within the periphery, the resolution can be lowered even further towards the outer boundaries where rod density declines. So this operation allows efficient and perceptually optimized rendering by leveraging the differences in foveal versus peripheral vision.

In operation 1312, the night mode component 728 renders the peripheral region at a lower temporal resolution compared to the foveal region. For example, the night mode component 728 renders the peripheral region at a lower temporal resolution compared to the foveal region. Based on identifying the peripheral area from the eye tracking data, the night mode component 728 displays content in this region at a reduced frame rate or refresh rate compared to the foveal gaze region. This leverages the differences in temporal response between rod and cone photoreceptors. Rods are slower to respond to changes in light intensity. So in the peripheral region, the night mode component 728 can render content at a lower frame rate, such as 1/2 to 1/3 the foveal rate, while remaining perceptible to rods. This conserves processing power. The degree of reduced frame rate can be tailored based on the estimated level of scotopic adaptation. So this operation optimizes the refresh rate based on the capabilities of peripheral night vision, reducing power consumption.

In operation 1314, the night mode component 728 decolorizes content while preserving contrast in the peripheral region. For example, for the content rendered in the peripheral area outside the foveal gaze region, the night mode component 728 converts the RGB colors to grayscale. The night mode component 728 applies a decolorization algorithm that maintains or enhances the relative contrast between different grayscale levels. So although color information is removed, the contrast and dynamic range of the original content is retained as much as possible. This allows conveying maximal information to the rods within their perceptive limits, while avoiding excess stimulation that could interfere with scotopic adaptation. So the decolorization balances information preservation and night vision protection.

FIG. 14 illustrates an example non-eye-tracking based rendering method 1400 used by the night mode component 728 of FIG. 7. Although the example non-eye-tracking based rendering method 1400 depicts a particular sequence of operations, the sequence may be altered without departing from the scope of the present disclosure. For example, some of the operations depicted may be performed in parallel or in a different sequence that does not materially affect the function of the non-eye-tracking based rendering method 1400. In other examples, different components of an example device or system that implements the non-eye-tracking based rendering method 1400 may perform functions at substantially the same time or in a specific sequence.

In operation 1402, the night mode component 728 provides at least one rendering mode such as, but not limited to: 1) mode using wavelengths above 640 nm; 2) mode using 498 nm wavelength light; and 3) dim RGB color mode. For example, the night mode component 728 makes these three rendering modes available to select based on the application and whether disrupting rods' night vision is acceptable.

The mode using only wavelengths above 640 nm avoids stimulating the rods, thereby fully preserving scotopic adaptation. This mode may be optimal when night vision must be protected.

The 498 nm mode leverages the wavelength rods are most sensitive to, allowing some peripheral content while reducing power. However, rods' dark adaptation may be partially disrupted.

The dim RGB mode provides colorful foveal content visible to cones, but rods may also be illuminated, reducing their night vision. This mode conveys the most information but impacts dark adaptation the most.

So the night mode component 728 provides this range of options balancing information, power, and night vision based on context, use case, and user preference.

In operation 1404, the night mode component 728 selects a rendering mode based on the application. For example, the choice of night mode rendering can depend on the application context and priorities:
Applications where fully preserving night vision is critical (e.g. military, astronomy) may strictly use the >640 nm mode to avoid any rod stimulation.
Applications that augment low-light real world environments (e.g. night hiking) may opt for the 498 nm mode to overlay some peripheral content without completely disrupting dark adaptation.
Applications displaying detailed colorful content (e.g. gaming, video) may utilize the dim RGB mode to provide rich visuals despite impacting rods' night vision.
Safety-oriented applications (e.g. night driving) may choose the 498 nm or >640 nm mode to avoid overly distracting peripheral content.
Power-constrained applications (e.g. low battery) could use the 498 nm mode to conserve energy.
Applications intending a quick burst of night vision disruption (e.g. notifications) could briefly use the dim RGB mode.

In operation 1406, for night modes 1 and 2, the night mode component 728 decolorizes the AR content while preserving contrast in the 640 nm or 498 nm wavelength modes. For example, for a mode using only wavelengths above 640 nm, since this red light is invisible to rods, the content can be shown in full color to stimulate the L-cones in the fovea. However, to conserve power, the night mode component 728 converts this colorful foveal content to grayscale, removing hues.

Similarly, for the 498 nm mode, the content is converted to grayscale to avoid excess rod stimulation that could disrupt dark adaptation. However, rather than simply converting to grayscale, which reduces contrast, the night mode component 728 applies a decolorization algorithm. This preserves the relative contrast between different grayscale levels, maintaining the dynamic range and visual distinctiveness of the original content as much as possible. For example, the image is converted to CIELAB colorspace where the L channel represents lightness and the A and B channels represent color opponents. The image is then decolorized by zeroing out the A and B channels while retaining the L channel. This removes color information while maintaining contrast in lightness.

In some examples, another color opponent model such as, but not limited to, YUV is used, where Y contains luma or brightness information. The U and V chroma channels are discarded to decolorize while keeping the luma channel Y to preserve contrast.

In some examples, a color histogram matching is used to decolorize to a reference grayscale image with desired contrast and lighting properties.

Accordingly, for these two peripheral-sparing night modes, the night mode component 728 leverages decolorization to balance impact on night vision and preservation of information.

In operation 1408, the night mode component 728 adjusts a brightness of the AR content to be similar to the objects in the environment. For example, the night mode component 728 analyzes the image data captured by the camera to estimate the ambient brightness levels of the physical environment. Based on this analysis, the night mode component 728 configures the XR display brightness to match the scene.

For example, if the environment is dim, the virtual content is rendered dimly to avoid a large discrepancy that could interfere with dark adaptation. In some cases, the AR brightness may exceed the environment slightly to remain visible while the user's eyes are adapting. But generally, the goal is for the virtual and real brightness to be as consistent as possible.

This synchronization of real and virtual brightness helps avoid excessive stimulation of rods or cones. It also provides a more natural and seamless viewing experience during night mode since the AR content blends into the environment. This operation aims to balance AR visibility, adaptation disruption, and realism by matching real-world scene brightness as closely as possible.

In operation 1410, the night mode component 728 places the AR content on a dark portion of the real-world scene 718 environment. For example, the night mode component 728 performs an analysis of the captured image data to detect regions of the environment that are darker versus brighter. For example, it may detect surfaces, objects, or portions of objects that have low measured luminance levels.

When determining where to overlay AR content, the night mode component 728 prioritizes the detected dark regions. For instance, virtual text or graphics are positioned on top of dark walls, or virtual characters are placed in dimly lit corners. This avoids exacerbating the total brightness in a region by overlaying with virtual content. If AR content was simply overlaid arbitrarily, it could significantly increase the local luminance if placed on already bright surfaces or objects. This excessive stimulation could interfere with dark adaptation. By intelligently positioning AR content preferentially in dark areas, the overall brightness is more likely to remain close to the original real environment. In some examples, a determine of where to place XR content is based on what a user can see at their currently estimated dark adaptation level, rather than what a camera can detect (e.g., dark objects that the eyes of the user cannot see are identified as being part of the background even though these dark objects can be detected by cameras). This helps maintain a natural scene appearance during night mode, while supporting the user's transition to scotopic or mesopic vision.

### Machine-Learning Pipeline

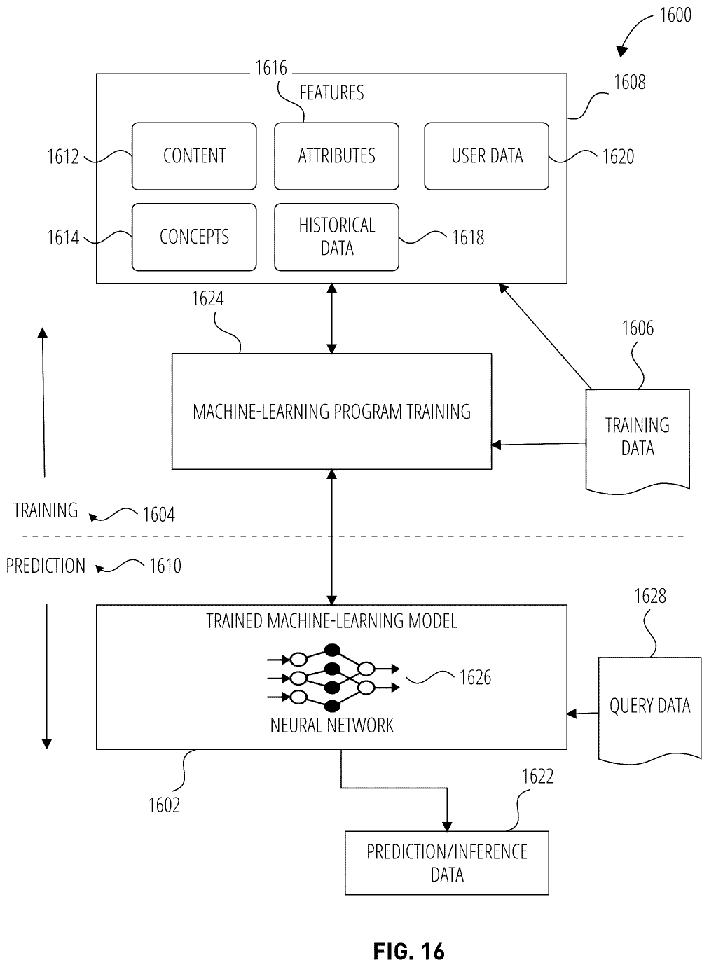

FIG. 16 is a flowchart depicting a machine-learning pipeline 1600, according to some examples. The machine-learning pipeline 1600 may be used to generate a trained machine-learning model 1602, for example a dark adaptation model 736 of FIG. 7, to perform operations associated with providing a night mode.

### Overview

Broadly, machine learning may involve using computer algorithms to automatically learn patterns and relationships in data, potentially without the need for explicit programming. Machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Three example types of problems in machine learning are classification problems, regression problems, and generation problems. Classification problems, also referred to as categorization problems, aim at classifying items into one of several category values (for example, is this object an apple or an orange?). Regression algorithms aim at quantifying some items (for example, by providing a value that is a real number). Generation algorithms aim at producing new examples that are similar to examples provided for training. For instance, a text generation algorithm is trained on many text documents and is configured to generate new coherent text with similar statistical properties as the training data.

### Training Phases

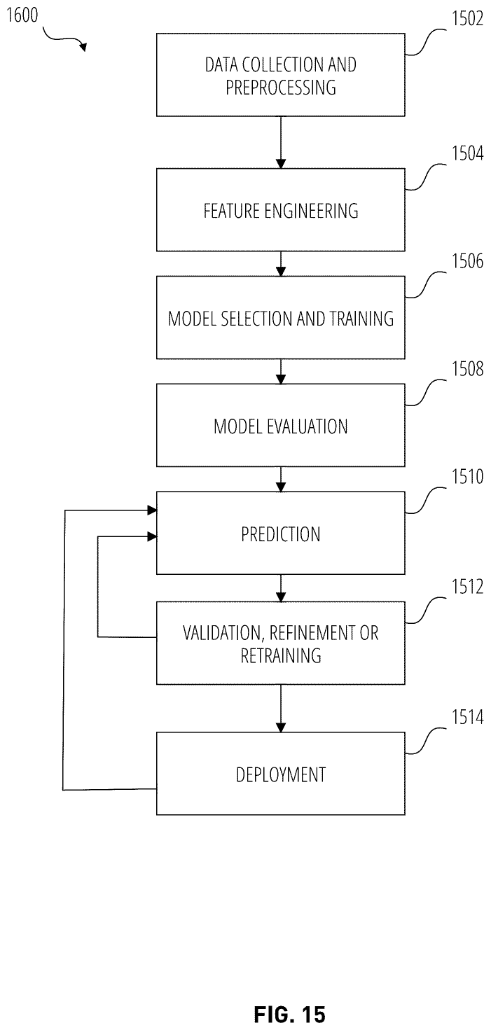

Generating a trained machine-learning model 1602 may include multiple phases that form part of the machine-learning pipeline 1600, including for example the following phases illustrated in FIG. 15:
Data collection and preprocessing 1502: This phase may include acquiring and cleaning data to ensure that it is suitable for use in the machine learning model. This phase may also include removing duplicates, handling missing values, and converting data into a suitable format.
Feature engineering 1504: This phase may include selecting and transforming the training data 1606 to create features that are useful for predicting the target variable. Feature engineering may include (1) receiving features 1608 (e.g., as structured or labeled data in supervised learning) and/or (2) identifying features 1608 (e.g., unstructured or unlabeled data for unsupervised learning) in training data 1606.
Model selection and training 1506: This phase may include selecting an appropriate machine learning algorithm and training it on the preprocessed data. This phase may further involve splitting the data into training and testing sets, using cross-validation to evaluate the model, and tuning hyperparameters to improve performance.
Model evaluation 1508: This phase may include evaluating the performance of a trained model (e.g., the trained machine-learning model 1602) on a separate testing dataset. This phase can help determine if the model is overfitting or underfitting and determine whether the model is suitable for deployment.
Prediction 1510: This phase involves using a trained model (e.g., trained machine-learning model 1602) to generate predictions on new, unseen data.
Validation, refinement or retraining 1512: This phase may include updating a model based on feedback generated from the prediction phase, such as new data or user feedback.
Deployment 1514: This phase may include integrating the trained model (e.g., the trained machine-learning model 1602) into a more extensive system or application, such as a web service, mobile app, or IoT device. This phase can involve setting up APIs, building a user interface, and ensuring that the model is scalable and can handle large volumes of data.

FIG. 16 illustrates further details of two example phases, namely a training phase 1604 (e.g., part of the model selection and trainings 1506) and a prediction phase 1610 (part of prediction 1510). Prior to the training phase 1604, feature engineering 1504 is used to identify features 1608. This may include identifying informative, discriminating, and independent features for effectively operating the trained machine-learning model 1602 in pattern recognition, classification, and regression. In some examples, the training data 1606 includes labeled data, known for pre-identified features 1608 and one or more outcomes. Each of the features 1608 may be a variable or attribute, such as an individual measurable property of a process, article, system, or phenomenon represented by a data set (e.g., the training data 1606). Features 1608 may also be of different types, such as numeric features, strings, and graphs, and may include one or more of content 1612, concepts 1614, attributes 1616, historical data 1618, and/or user data 1620, merely for example.

In training phase 1604, the machine-learning pipeline 1600 uses the training data 1606 to find correlations among the features 1608 that affect a predicted outcome or prediction/inference data 1622.

With the training data 1606 and the identified features 1608, the trained machine-learning model 1602 is trained during the training phase 1604 during machine-learning program training 1624. The machine-learning program training 1624 appraises values of the features 1608 as they correlate to the training data 1606. The result of the training is the trained machine-learning model 1602 (e.g., a trained or learned model).

Further, the training phase 1604 may involve machine learning, in which the training data 1606 is structured (e.g., labeled during preprocessing operations). The trained machine-learning model 1602 implements a neural network 1626 capable of performing, for example, classification and clustering operations. In other examples, the training phase 1604 may involve deep learning, in which the training data 1606 is unstructured, and the trained machine-learning model 1602 implements a deep neural network 1626 that can perform both feature extraction and classification/clustering operations.

In some examples, a neural network 1626 may be generated during the training phase 1604, and implemented within the trained machine-learning model 1602. The neural network 1626 includes a hierarchical (e.g., layered) organization of neurons, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron in the neural network 1626 operationally computes a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 1626 may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 1604, a validation phase may be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model may be tested on a new dataset. The testing dataset is used to evaluate the model's performance and ensure that the model has not overfitted the training data.

In prediction phase 1610, the trained machine-learning model 1602 uses the features 1608 for analyzing query data 1628 to generate inferences, outcomes, or predictions, as examples of a prediction/inference data 1622. For example, during prediction phase 1610, the trained machine-learning model 1602 generates an output. Query data 1628 is provided as an input to the trained machine-learning model 1602, and the trained machine-learning model 1602 generates the prediction/inference data 1622 as output, responsive to receipt of the query data 1628.

In some examples, the trained machine-learning model 1602 may be a generative AI model. Generative AI is a term that may refer to any type of artificial intelligence that can create new content from training data 1606. For example, generative AI can produce text, images, video, audio, code, or synthetic data similar to the original data but not identical.

Some of the techniques that may be used in generative AI are:
Convolutional Neural Networks (CNNs): CNNs may be used for image recognition and computer vision tasks. CNNs may, for example, be designed to extract features from images by using filters or kernels that scan the input image and highlight important patterns.
Recurrent Neural Networks (RNNs): RNNs may be used for processing sequential data, such as speech, text, and time series data, for example. RNNs employ feedback loops that allow them to capture temporal dependencies and remember past inputs.
Generative adversarial networks (GANs): GANs may include two neural networks: a generator and a discriminator. The generator network attempts to create realistic content that can “fool” the discriminator network, while the discriminator network attempts to distinguish between real and fake content. The generator and discriminator networks compete with each other and improve over time.
Variational autoencoders (VAEs): VAEs may encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies.
Transformer models: Transformer models may use attention mechanisms to learn the relationships between different parts of input data (such as words or pixels) and generate output data based on these relationships. Transformer models can handle sequential data, such as text or speech, as well as non-sequential data, such as images or code.

In generative AI examples, the query data 1628 may include text, audio, image, video, numeric, or media content prompts and the output prediction/inference data 1622 includes text, images, video, audio, code, or synthetic data.

In some examples, the night mode component 728 collects real-time dark adaptation level data and continuously re-trains the dark adaptation model 736 in real time using the dark adaptation level data. For example, the night mode component 728 uses a method such as, but not limited to, the physiological dark adaptation estimation method 900 of FIG. 9, an eye-tracking-based adaptation estimation method 1000 of FIG. 10, and the like, to collect the dark adaptation level data.

### Systems

FIG. 17 illustrates a system 1700 including a head-wearable apparatus 100, according to some examples. FIG. 17 is a high-level functional block diagram of an example head-wearable apparatus 100 communicatively coupled to a mobile device 1714 and various server systems 1704 (e.g., the interaction server system 1812) via various networks 1810.

The head-wearable apparatus 100 includes one or more cameras, each of which may be, for example, one or more camera 1708, a light emitter 1710, and one or more wide-spectrum cameras 1712.

The mobile device 1714 connects with head-wearable apparatus 100 using both a low-power wireless connection 1716 and a high-speed wireless connection 1718. The mobile device 1714 is also connected to the server system 1704 and the network 1706.

The head-wearable apparatus 100 further includes two image displays of the image display of optical assembly 1720. The two image displays of optical assembly 1720 include one associated with the left lateral side and one associated with the right lateral side of the head-wearable apparatus 100. The head-wearable apparatus 100 also includes an image display driver 1722, and a GPU 1724. The image display of optical assembly 1720, image display driver 1722, and GPU 1724 constitute an optical engine of the head-wearable apparatus 100. The image display of optical assembly 1720 is for presenting images and videos, including an image that can include a graphical user interface (GUI) to a user of the head-wearable apparatus 100.

The image display driver 1722 commands and controls the image display of optical assembly 1720. The image display driver 1722 may deliver image data directly to the image display of optical assembly 1720 for presentation or may convert the image data into a signal or data format suitable for delivery to the image display device. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (EXIF) or the like.

The head-wearable apparatus 100 includes a frame and stems (or temples) extending from a lateral side of the frame. The head-wearable apparatus 100 further includes a user input device 1730 (e.g., touch sensor or push button), including an input surface on the head-wearable apparatus 100. The user input device 1730 (e.g., touch sensor or push button) is to receive from the user an input selection to manipulate the GUI of the presented image.

The components shown in FIG. 17 for the head-wearable apparatus 100 are located on one or more circuit boards, for example a PCB or flexible PCB, in the rims or temples. Alternatively, or additionally, the depicted components can be located in the chunks, frames, hinges, or bridge of the head-wearable apparatus 100. Left and right cameras 1708 can include digital camera elements such as a complementary metal oxide-semiconductor (CMOS) image sensor, charge-coupled device, camera lenses, or any other respective visible or light-capturing elements that may be used to capture data, including images of scenes with unknown objects.

The head-wearable apparatus 100 includes a memory 1702, which stores instructions to perform a subset or all of the functions described herein. The memory 1702 can also include storage device.

As shown in FIG. 17, the high-speed circuitry 1728 includes a high-speed processor 1732, a memory 1702, and high-speed wireless circuitry 1734. In some examples, the image display driver 1722 is coupled to the high-speed circuitry 1728 and operated by the high-speed processor 1732 in order to drive the left and right image displays of the image display of optical assembly 1720. The high-speed processor 1732 may be any processor capable of managing high-speed communications and operation of any general computing system needed for the head-wearable apparatus 100. The high-speed processor 1732 includes processing resources needed for managing high-speed data transfers on a high-speed wireless connection 1718 to a wireless local area network (WLAN) using the high-speed wireless circuitry 1734. In certain examples, the high-speed processor 1732 executes an operating system such as a LINUX operating system or other such operating system of the head-wearable apparatus 100, and the operating system is stored in the memory 1702 for execution. In addition to any other responsibilities, the high-speed processor 1732 executing a software architecture for the head-wearable apparatus 100 is used to manage data transfers with high-speed wireless circuitry 1734. In certain examples, the high-speed wireless circuitry 1734 is configured to implement Institute of Electrical and Electronic Engineers (IEEE) 802.11 communication standards, also referred to herein as WiFi. In some examples, other high-speed communications standards may be implemented by the high-speed wireless circuitry 1734.

The low-power wireless circuitry 1736 and the high-speed wireless circuitry 1734 of the head-wearable apparatus 100 can include short-range transceivers (Bluetooth™) and wireless wide, local, or wide area network (WAN) transceivers (e.g., cellular or WiFi). Mobile device 1714, including the transceivers communicating via the low-power wireless connection 1716 and the high-speed wireless connection 1718, may be implemented using details of the architecture of the head-wearable apparatus 100, as can other elements of the network 1706.

The memory 1702 includes any storage device capable of storing various data and applications, including, among other things, camera data generated by the left and right cameras 1708, the wide-spectrum cameras 1712, and the GPU 1724, as well as images generated for display by the image display driver 1722 on the image displays of the image display of optical assembly 1720. While the memory 1702 is shown as integrated with high-speed circuitry 1728, in some examples, the memory 1702 may be an independent standalone element of the head-wearable apparatus 100. In certain such examples, electrical routing lines may provide a connection through a chip that includes the high-speed processor 1732 from the GPU 1724 or the low-power processor 1738 to the memory 1702. In some examples, the high-speed processor 1732 may manage addressing of the memory 1702 such that the low-power processor 1738 will boot the high-speed processor 1732 any time that a read or write operation involving memory 1702 is needed.

As shown in FIG. 17, the low-power processor 1738 or high-speed processor 1732 of the head-wearable apparatus 100 can be coupled to the camera (camera 1708, light emitter 1710, or wide-spectrum cameras 1712), the image display driver 1722, the user input device 1730 (e.g., touch sensor or push button), and the memory 1702.

The head-wearable apparatus 100 is connected to a host computer. For example, the head-wearable apparatus 100 is paired with the mobile device 1714 via the high-speed wireless connection 1718 or connected to the server system 1704 via the network 1706. The server system 1704 may be one or more computing devices as part of a service or network computing system, for example, that includes a processor, a memory, and network communication interface to communicate over the network 1706 with the mobile device 1714 and the head-wearable apparatus 100.

The mobile device 1714 includes a processor and a network communication interface coupled to the processor. The network communication interface allows for communication over the network 1706, low-power wireless connection 1716, or high-speed wireless connection 1718. Mobile device 1714 can further store at least portions of the instructions for generating binaural audio content in the mobile device 1714's memory to implement the functionality described herein.

Output components of the head-wearable apparatus 100 include visual components, such as a display such as a LCD, a PDP, a LED display, a projector, or a waveguide. The image displays of the optical assembly are driven by the image display driver 1722. The output components of the head-wearable apparatus 100 further include acoustic components (e.g., speakers), haptic components (e.g., a vibratory motor), other signal generators, and so forth. The input components of the head-wearable apparatus 100, the mobile device 1714, and server system 1704, such as the user input device 1730, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 100 may also include additional peripheral device elements. Such peripheral device elements may include biometric sensors, additional sensors, or display elements integrated with the head-wearable apparatus 100. For example, peripheral device elements may include any I/O components including output components, motion components, position components, or any other such elements described herein.

For example, the biometric components include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components include acceleration sensor components (e.g., accelerometer), gravitation sensor components, rotation sensor components (e.g., gyroscope), and so forth. The position components include location sensor components to generate location coordinates (e.g., a GPS receiver component), Wi-Fi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over low-power wireless connections 1716 and high-speed wireless connection 1718 from the mobile device 1714 via the low-power wireless circuitry 1736 or high-speed wireless circuitry 1734.

### Networked Computing Environment

FIG. 18 is a block diagram showing an example interaction system 1800 for facilitating interactions (e.g., exchanging text messages, conducting text audio and video calls, or playing games) over a network. The interaction system 1800 includes one or more XR systems, such as XR computing system 1802, each of which hosts multiple applications, including an interaction client 1806 and other applications 1808. Each interaction client 1806 is communicatively coupled, via one or more communication networks including a network 1810 (e.g., the Internet), to other instances of the interaction client 1806 (e.g., hosted on respective other computing systems such as computing system 1804), an interaction server system 1812 and third-party servers 1814). An interaction client 1806 can also communicate with locally hosted applications 1808 using Application Programming Interfaces (APIs).

Each XR system 1802 may comprise one or more user devices, such as a mobile device 1714, head-wearable apparatus 100, and a computer client device 1816 that are communicatively connected to exchange data and messages.

An interaction client 1806 interacts with other interaction clients 1806 and with the interaction server system 1812 via the network 1810. The data exchanged between the interaction clients 1806 (e.g., interactions 1818) and between the interaction clients 1806 and the interaction server system 1812 includes functions (e.g., commands to invoke functions) and payload data (e.g., text, audio, video, or other multimedia data).

The interaction server system 1812 provides server-side functionality via the network 1810 to the interaction clients 1806. While certain functions of the interaction system 1800 are described herein as being performed by either an interaction client 1806 or by the interaction server system 1812, the location of certain functionality either within the interaction client 1806 or the interaction server system 1812 may be a design choice. For example, it may be technically preferable to initially deploy particular technology and functionality within the interaction server system 1812 but to later migrate this technology and functionality to the interaction client 1806 where an XR system 1802 has sufficient processing capacity.

The interaction server system 1812 supports various services and operations that are provided to the interaction clients 1806. Such operations include transmitting data to, receiving data from, and processing data generated by the interaction clients 1806. This data may include message content, client device information, geolocation information, media augmentation and overlays, message content persistence conditions, social network information, and live event information. Data exchanges within the interaction system 1800 are invoked and controlled through functions available via user interfaces (UIs) of the interaction clients 1806.

Turning now specifically to the interaction server system 1812, an API server 1820 is coupled to and provides programmatic interfaces to Interaction servers 1822, making the functions of the Interaction servers 1822 accessible to interaction clients 1806, other applications 1808 and third-party server 1814. The Interaction servers 1822 are communicatively coupled to a database server 1824, facilitating access to a database 1826 that stores data associated with interactions processed by the Interaction servers 1822. Similarly, a web server 1828 is coupled to the Interaction servers 1822 and provides web-based interfaces to the Interaction servers 1822. To this end, the web server 1828 processes incoming network requests over the HTTP and several other related protocols.

The API server 1820 receives and transmits interaction data (e.g., commands and message payloads) between the interaction servers 1822 and the XR system 1802 (and, for example, interaction clients 1806 and other applications 1808) and the third-party server 1814. Specifically, the API server 1820 provides a set of interfaces (e.g., routines and protocols) that can be called or queried by the interaction client 1806 and other applications 1808 to invoke functionality of the interaction servers 1822. The API server 1820 exposes various functions supported by the interaction servers 1822, including account registration; login functionality; the sending of interaction data, via the interaction servers 1822, from a particular interaction client 1806 to another interaction client 1806; the communication of media files (e.g., images or video) from an interaction client 1806 to the interaction servers 1822; the settings of a collection of media data (e.g., a story); the retrieval of a list of friends of a user of an XR system 1802; the retrieval of messages and content; the addition and deletion of entities (e.g., friends) to an entity graph (e.g., a social graph); the location of friends within a social graph; and opening an application event (e.g., relating to the interaction client 1806).

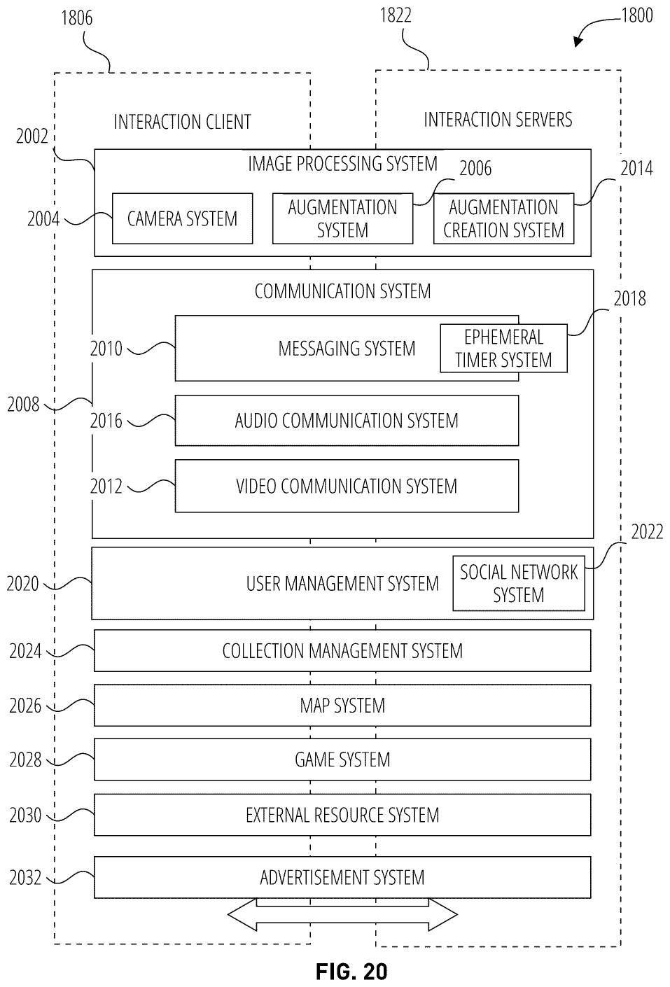

The interaction servers 1822 host multiple systems and subsystems, described below with reference to FIG. 20. Returning to the interaction client 1806, features and functions of an external resource (e.g., a linked application 1808 or applet) are made available to a user via an interface of the interaction client 1806. In this context, “external” refers to the fact that the application 1808 or applet is external to the interaction client 1806. The external resource is often provided by a third party but may also be provided by the creator or provider of the interaction client 1806. The interaction client 1806 receives a user selection of an option to launch or access features of such an external resource. The external resource may be the application 1808 installed on the XR system 1802 (e.g., a “native app”), or a small-scale version of the application (e.g., an “applet”) that is hosted on the XR system 1802 or remote of the XR system 1802 (e.g., on third-party servers 1814). The small-scale version of the application includes a subset of features and functions of the application (e.g., the full-scale, native version of the application) and is implemented using a markup-language document. In some examples, the small-scale version of the application (e.g., an “applet”) is a web-based, markup-language version of the application and is embedded in the interaction client 1806. In addition to using markup-language documents (e.g., a .*ml file), an applet may incorporate a scripting language (e.g., a .*js file or a .json file) and a style sheet (e.g., a .*ss file).

In response to receiving a user selection of the option to launch or access features of the external resource, the interaction client 1806 determines whether the selected external resource is a web-based external resource or a locally installed application 1808. In some cases, applications 1808 that are locally installed on the XR system 1802 can be launched independently of and separately from the interaction client 1806, such as by selecting an icon corresponding to the application 1808 on a home screen of the XR system 1802. Small-scale versions of such applications can be launched or accessed via the interaction client 1806 and, in some examples, no or limited portions of the small-scale application can be accessed outside of the interaction client 1806. The small-scale application can be launched by the interaction client 1806 receiving, from a third-party server 1814 for example, a markup-language document associated with the small-scale application and processing such a document.

In response to determining that the external resource is a locally installed application 1808, the interaction client 1806 instructs the XR system 1802 to launch the external resource by executing locally-stored code corresponding to the external resource. In response to determining that the external resource is a web-based resource, the interaction client 1806 communicates with the third-party servers 1814 (for example) to obtain a markup-language document corresponding to the selected external resource. The interaction client 1806 then processes the obtained markup-language document to present the web-based external resource within a user interface of the interaction client 1806.

The interaction client 1806 can notify a user of the XR system 1802, or other users related to such a user (e.g., “friends”), of activity taking place in one or more external resources. For example, the interaction client 1806 can provide participants in a conversation (e.g., a chat session) in the interaction client 1806 with notifications relating to the current or recent use of an external resource by one or more members of a group of users. One or more users can be invited to join in an active external resource or to launch a recently used but currently inactive (in the group of friends) external resource. The external resource can provide participants in a conversation, each using respective interaction clients 1806, with the ability to share an item, status, state, or location in an external resource in a chat session with one or more members of a group of users. The shared item may be an interactive chat card with which members of the chat can interact, for example, to launch the corresponding external resource, view specific information within the external resource, or take the member of the chat to a specific location or state within the external resource. Within a given external resource, response messages can be sent to users on the interaction client 1806. The external resource can selectively include different media items in the responses, based on a current context of the external resource.

The interaction client 1806 can present a list of the available external resources (e.g., applications 1808 or applets) to a user to launch or access a given external resource. This list can be presented in a context-sensitive menu. For example, the icons representing different ones of the application 1808 (or applets) can vary based on how the menu is launched by the user (e.g., from a conversation interface or from a non-conversation interface).

### Data Architecture

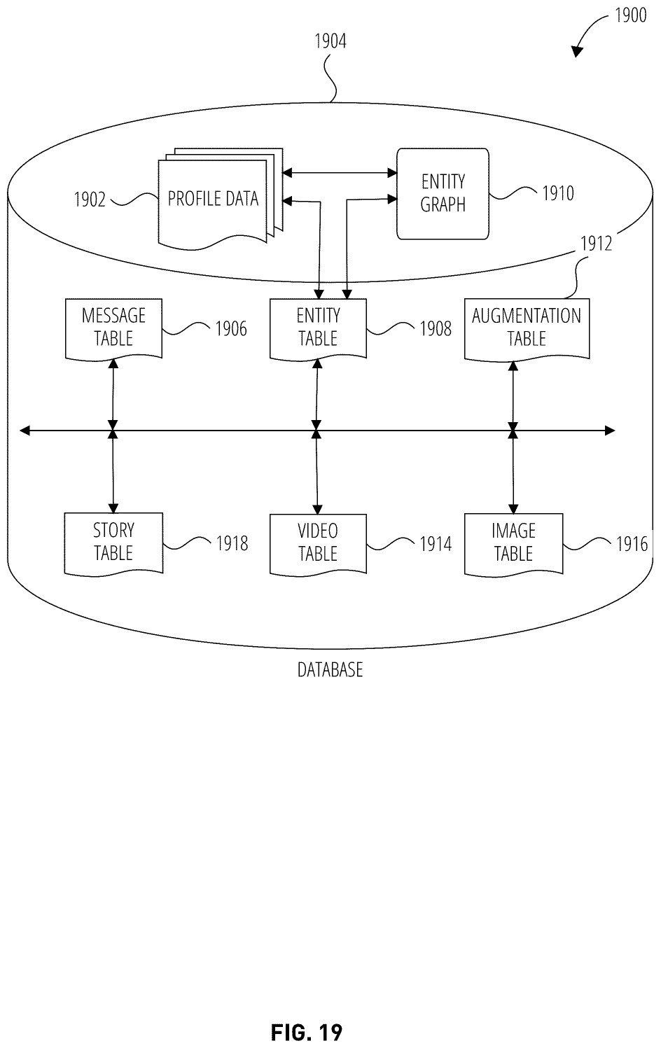

FIG. 19 is a schematic diagram illustrating data structures 1900, which may be stored in the database 1904 of the interaction server system 1812, according to certain examples. While the content of the database 1904 is shown to comprise multiple tables, it will be appreciated that the data could be stored in other types of data structures (e.g., as an object-oriented database).

The database 1904 includes message data stored within a message table 1906. This message data includes, for any particular message, at least message sender data, message recipient (or receiver) data, and a payload. Further details regarding information that may be included in a message, and included within the message data stored in the message table 1906, are described below with reference to FIG. 19.

An entity table 1908 stores entity data, and is linked (e.g., referentially) to an entity graph 1910 and profile data 1902. Entities for which records are maintained within the entity table 1908 may include individuals, corporate entities, organizations, objects, places, events, and so forth. Regardless of entity type, any entity regarding which the interaction server system 1812 stores data may be a recognized entity. Each entity is provided with a unique identifier, as well as an entity type identifier (not shown).

The entity graph 1910 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the interaction system 1800.

Certain permissions and relationships may be attached to each relationship, and also to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user and may significantly restrict or block the publication of digital content from the individual user to the commercial user. A particular user, as an example of an entity, may record certain restrictions (e.g., by way of privacy settings) in a record for that entity within the entity table 1908. Such privacy settings may be applied to all types of relationships within the context of the interaction system 1800 or may selectively be applied to only certain types of relationships.

The profile data 1902 stores multiple types of profile data about a particular entity. The profile data 1902 may be selectively used and presented to other users of the interaction system 1800 based on privacy settings specified by a particular entity. Where the entity is an individual, the profile data 1902 includes, for example, a username, telephone number, address, settings (e.g., notification and privacy settings), as well as a user-selected avatar representation (or collection of such avatar representations). A particular user may then selectively include one or more of these avatar representations within the content of messages communicated via the interaction system 1800, and on map interfaces displayed by interaction clients 1806 to other users. The collection of avatar representations may include “status avatars,” which present a graphical representation of a status or activity that the user may select to communicate at a particular time.

Where the entity is a group, the profile data 1902 for the group may similarly include one or more avatar representations associated with the group, in addition to the group name, members, and various settings (e.g., notifications) for the relevant group.

The database 1904 also stores augmentation data, such as overlays or filters, in an augmentation table 1912. The augmentation data is associated with and applied to videos (for which data is stored in a video table 1914) and images (for which data is stored in an image table 1916).

Filters, in some examples, are overlays that are displayed as overlaid on an image or video during presentation to a message receiver. Filters may be of various types, including user-selected filters from a set of filters presented to a message sender by the interaction client 1806 when the message sender is composing a message. Other types of filters include geolocation filters (also known as geo-filters), which may be presented to a message sender based on geographic location. For example, geolocation filters specific to a neighborhood or special location may be presented within a user interface by the interaction client 1806, based on geolocation information determined by a GPS unit of the XR system 1802.

Another type of filter is a data filter, which may be selectively presented to a message sender by the interaction client 1806 based on other inputs or information gathered by the XR system 1802 during the message creation process. Examples of data filters include current temperature at a specific location, a current speed at which a message sender is traveling, battery life for an XR system 1802, or the current time.

Other augmentation data that may be stored within the image table 1916 includes XR content items (e.g., corresponding to applying XR experiences to live or previously captured images or video). An XR content item may be a real-time special effect and sound that may be added to an image or a video.

As described above, augmentation data includes XR, VR, and XR content items, overlays, image transformations, images, and modifications that may be applied to image data (e.g., videos or images). This includes real-time modifications, which modify an image as it is captured using device sensors (e.g., one or multiple cameras) of the XR system 1802 and then displayed on a screen of the XR system 1802 with the modifications. This also includes modifications to stored content, such as video clips in a collection or group that may be modified. For example, in an XR system 1802 with access to multiple XR content items, a user can use a single video clip with multiple XR content items to see how the different XR reality content items will modify the stored clip. Similarly, real-time video capture may use modifications to show how video images currently being captured by sensors of an XR system 1802 would modify the captured data. Such data may simply be displayed on the screen and not stored in memory, or the content captured by the device sensors may be recorded and stored in memory with or without the modifications (or both). In some systems, a preview feature can show how different XR content items will look within different windows in a display at the same time. This can, for example, enable multiple windows with different pseudorandom animations to be viewed on a display at the same time.

Data and various systems using XR content items or other such transform systems to modify content using this data can thus involve detection of objects (e.g., faces, hands, bodies, cats, dogs, surfaces, objects, etc.), tracking of such objects as they leave, enter, and move around the field of view in video frames, and the modification or transformation of such objects as they are tracked. In various examples, different methods for achieving such transformations may be used. Some examples may involve generating a 3D mesh model of the object or objects and using transformations and animated textures of the model within the video to achieve the transformation. In some examples, tracking of points on an object may be used to place an image or texture (which may be 2D or 3Dl) at the tracked position. In still further examples, neural network analysis of video frames may be used to place images, models, or textures in content (e.g., images or frames of video). XR content items thus refer both to the images, models, and textures used to create transformations in content, as well as to additional modeling and analysis information needed to achieve such transformations with object detection, tracking, and placement.

Real-time video processing can be performed with any kind of video data (e.g., video streams, video files, etc.) saved in a memory of a computerized system of any kind. For example, a user can load video files and save them in a memory of a device, or can generate a video stream using sensors of the device. Additionally, any objects can be processed using a computer animation model, such as a human's face and parts of a human body, animals, or non-living things such as chairs, cars, or other objects.

In some examples, when a particular modification is selected along with content to be transformed, elements to be transformed are identified by the computing device, and then detected and tracked if they are present in the frames of the video. The elements of the object are modified according to the request for modification, thus transforming the frames of the video stream. Transformation of frames of a video stream can be performed by different methods for different kinds of transformation. For example, for transformations of frames mostly referring to changing forms of an object's elements, characteristic points for each element of an object are calculated (e.g., using an Active Shape Model (ASM) or other known methods). Then, a mesh based on the characteristic points is generated for each element of the object. This mesh is used in the following stage of tracking the elements of the object in the video stream. In the process of tracking, the mesh for each element is aligned with a position of each element. Then, additional points are generated on the mesh.

In some examples, transformations changing some areas of an object using its elements can be performed by calculating characteristic points for each element of an object and generating a mesh based on the calculated characteristic points. Points are generated on the mesh, and then various areas based on the points are generated. The elements of the object are then tracked by aligning the area for each element with a position for each of the at least one element, and properties of the areas can be modified based on the request for modification, thus transforming the frames of the video stream. Depending on the specific request for modification, properties of the mentioned areas can be transformed in different ways. Such modifications may involve changing the color of areas; removing some part of areas from the frames of the video stream; including new objects into areas that are based on a request for modification; and modifying or distorting the elements of an area or object. In various examples, any combination of such modifications or other similar modifications may be used. For certain models to be animated, some characteristic points can be selected as control points to be used in determining the entire state-space of options for the model animation.

In some examples of a computer animation model to transform image data using face detection, the face is detected on an image using a specific face detection algorithm (e.g., Viola-Jones). Then, an ASM algorithm is applied to the face region of an image to detect facial feature reference points.

Other methods and algorithms suitable for face detection can be used. For example, in some examples, visual features are located using a landmark, which represents a distinguishable point present in most of the images under consideration. For facial landmarks, for example, the location of the left eye pupil may be used. If an initial landmark is not identifiable (e.g., if a person has an eyepatch), secondary landmarks may be used. Such landmark identification procedures may be used for any such objects. In some examples, a set of landmarks forms a shape. Shapes can be represented as vectors using the coordinates of the points in the shape. One shape is aligned to another with a similarity transform (allowing translation, scaling, and rotation) that minimizes the average Euclidean distance between shape points. The mean shape is the mean of the aligned training shapes.

A transformation system can capture an image or video stream on a client device (e.g., the XR system 1802) and perform complex image manipulations locally on the XR system 1802 while maintaining a suitable user experience, computation time, and power consumption. The complex image manipulations may include size and shape changes, emotion transfers (e.g., changing a face from a frown to a smile), state transfers (e.g., aging a subject, reducing apparent age, changing gender), style transfers, graphical element application, and any other suitable image or video manipulation implemented by a convolutional neural network that has been configured to execute efficiently on the XR system 1802.

In some examples, a computer animation model to transform image data can be used by a system where a user may capture an image or video stream of the user (e.g., a selfie) using the XR system 1802 having a neural network operating as part of an interaction client 1806 operating on the XR system 1802. The transformation system operating within the interaction client 1806 determines the presence of a face within the image or video stream and provides modification icons associated with a computer animation model to transform image data, or the computer animation model can be present as associated with an interface described herein. The modification icons include changes that are the basis for modifying the user's face within the image or video stream as part of the modification operation. Once a modification icon is selected, the transform system initiates a process to convert the image of the user to reflect the selected modification icon (e.g., generate a smiling face on the user). A modified image or video stream may be presented in a GUI displayed on the XR system 1802 as soon as the image or video stream is captured and a specified modification is selected. The transformation system may implement a complex convolutional neural network on a portion of the image or video stream to generate and apply the selected modification. That is, the user may capture the image or video stream and be presented with a modified result in real-time or near real-time once a modification icon has been selected. Further, the modification may be persistent while the video stream is being captured, and the selected modification icon remains toggled. Machine-taught neural networks may be used to enable such modifications.

The GUI, presenting the modification performed by the transform system, may supply the user with additional interaction options. Such options may be based on the interface used to initiate the content capture and selection of a particular computer animation model (e.g., initiation from a content creator user interface). In various examples, a modification may be persistent after an initial selection of a modification icon. The user may toggle the modification on or off by tapping or otherwise selecting the face being modified by the transformation system and store it for later viewing or browsing to other areas of the imaging application. Where multiple faces are modified by the transformation system, the user may toggle the modification on or off globally by tapping or selecting a single face modified and displayed within a GUI. In some examples, individual faces, among a group of multiple faces, may be individually modified, or such modifications may be individually toggled by tapping or selecting the individual face or a series of individual faces displayed within the GUI.

A story table 1918 stores data regarding collections of messages and associated image, video, or audio data, which are compiled into a collection (e.g., a story or a gallery). The creation of a particular collection may be initiated by a particular user (e.g., each user for which a record is maintained in the entity table 1908). A user may create a “personal story” in the form of a collection of content that has been created and sent/broadcast by that user. To this end, the user interface of the interaction client 1806 may include an icon that is user-selectable to enable a message sender to add specific content to his or her personal story.

A collection may also constitute a “live story,” which is a collection of content from multiple users that is created manually, automatically, or using a combination of manual and automatic techniques. For example, a “live story” may constitute a curated stream of user-submitted content from various locations and events. Users whose client devices have location services enabled and are at a common location event at a particular time may, for example, be presented with an option, via a user interface of the interaction client 1806, to contribute content to a particular live story. The live story may be identified to the user by the interaction client 1806, based on his or her location. The end result is a “live story” told from a community perspective.

A further type of content collection is known as a “location story,” which enables a user whose XR system 1802 is located within a specific geographic location (e.g., on a college or university campus) to contribute to a particular collection. In some examples, a contribution to a location story may require a second degree of authentication to verify that the end-user belongs to a specific organization or other entity (e.g., is a student on the university campus).

As mentioned above, the video table 1914 stores video data that, in some examples, is associated with messages for which records are maintained within the message table 1906. Similarly, the image table 1916 stores image data associated with messages for which message data is stored in the entity table 1908. The entity table 1908 may associate various augmentations from the augmentation table 1912 with various images and videos stored in the image table 1916 and the video table 1914.

The databases 1904 also includes social network information collected by the social network system 2022.

### System Architecture

FIG. 20 is a block diagram illustrating further details regarding the interaction system 1800, according to some examples. Specifically, the interaction system 1800 is shown to comprise the interaction client 1806 and the interaction servers 1822. The interaction system 1800 embodies multiple subsystems, which are supported on the client-side by the interaction client 1806 and on the server-side by the interaction servers 1822. Example subsystems are discussed below.

An image processing system 2002 provides various functions that enable a user to capture and augment (e.g., augment or otherwise modify or edit) media content associated with a message.

A camera system 2004 includes control software (e.g., in a camera application) that interacts with and controls hardware camera hardware (e.g., directly or via operating system controls) of the XR system 1802 to modify and augment real-time images captured and displayed via the interaction client 1806.

The augmentation system 2006 provides functions related to the generation and publishing of augmentations (e.g., media overlays) for images captured in real-time by cameras of the XR system 1802 or retrieved from memory of the XR system 1802. For example, the augmentation system 2006 operatively selects, presents, and displays media overlays (e.g., an image filter or an image lens) to the interaction client 1806 for the augmentation of real-time images received via the camera system 2004 or stored images retrieved from memory 1702 of an XR system 1802. These augmentations are selected by the augmentation system 2006 and presented to a user of an interaction client 1806, based on a number of inputs and data, such as for example:
Geolocation of the XR system 1802; and
Social network information of the user of the XR system 1802.

An augmentation may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo or video) at XR system 1802 for communication in a message, or applied to video content, such as a video content stream or feed transmitted from an interaction client 1806. As such, the image processing system 2002 may interact with, and support, the various subsystems of the communication system 2008, such as the messaging system 2010 and the video communication system 2012.

A media overlay may include text or image data that can be overlaid on top of a photograph taken by the XR system 1802 or a video stream produced by the XR system 1802. In some examples, the media overlay may be a location overlay (e.g., Venice beach), a name of a live event, or a name of a merchant overlay (e.g., Beach Coffee House). In further examples, the image processing system 2002 uses the geolocation of the XR system 1802 to identify a media overlay that includes the name of a merchant at the geolocation of the XR system 1802. The media overlay may include other indicia associated with the merchant. The media overlays may be stored in the databases 1826 and accessed through the database server 1824.

The image processing system 2002 provides a user-based publication platform that enables users to select a geolocation on a map and upload content associated with the selected geolocation. The user may also specify circumstances under which a particular media overlay should be offered to other users. The image processing system 2002 generates a media overlay that includes the uploaded content and associates the uploaded content with the selected geolocation.

The augmentation creation system 2014 supports XR developer platforms and includes an application for content creators (e.g., artists and developers) to create and publish augmentations (e.g., XR experiences) of the interaction client 1806. The augmentation creation system 2014 provides a library of built-in features and tools to content creators including, for example custom shaders, tracking technology, and templates.

In some examples, the augmentation creation system 2014 provides a merchant-based publication platform that enables merchants to select a particular augmentation associated with a geolocation via a bidding process. For example, the augmentation creation system 2014 associates a media overlay of the highest bidding merchant with a corresponding geolocation for a predefined amount of time.

A communication system 2008 is responsible for enabling and processing multiple forms of communication and interaction within the interaction system 1800 and includes a messaging system 2010, an audio communication system 2016, and a video communication system 2012. The messaging system 2010 is responsible for enforcing the temporary or time-limited access to content by the interaction clients 1806. The messaging system 2010 incorporates multiple timers (e.g., within an ephemeral timer system 2018) that, based on duration and display parameters associated with a message or collection of messages (e.g., a story), selectively enable access (e.g., for presentation and display) to messages and associated content via the interaction client 1806. Further details regarding the operation of the ephemeral timer system 2018 are provided below. The audio communication system 2016 enables and supports audio communications (e.g., real-time audio chat) between multiple interaction clients 1806. Similarly, the video communication system 2012 enables and supports video communications (e.g., real-time video chat) between multiple interaction clients 1806.

A user management system 2020 is operationally responsible for the management of user data and profiles, and includes a social network system 2022 that maintains social network information regarding relationships between users of the interaction system 1800.

A collection management system 2024 is operationally responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 2024 may also be responsible for publishing an icon that provides notification of a particular collection to the user interface of the interaction client 1806. The collection management system 2024 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 2024 employs machine vision (or image recognition technology) and content rules to curate a content collection automatically. In certain examples, compensation may be paid to a user to include user-generated content into a collection. In such cases, the collection management system 2024 operates to automatically make payments to such users to use their content.

A map system 2026 provides various geographic location functions and supports the presentation of map-based media content and messages by the interaction client 1806. For example, the map system 2026 enables the display of user icons or avatars (e.g., stored in profile data 1902) on a map to indicate a current or past location of “friends” of a user, as well as media content (e.g., collections of messages including photographs and videos) generated by such friends, within the context of a map. For example, a message posted by a user to the interaction system 1800 from a specific geographic location may be displayed within the context of a map at that particular location to “friends” of a specific user on a map interface of the interaction client 1806. A user can furthermore share his or her location and status information (e.g., using an appropriate status avatar) with other users of the interaction system 1800 via the interaction client 1806, with this location and status information being similarly displayed within the context of a map interface of the interaction client 1806 to selected users.

A game system 2028 provides various gaming functions within the context of the interaction client 1806. The interaction client 1806 provides a game interface providing a list of available games that can be launched by a user within the context of the interaction client 1806 and played with other users of the interaction system 1800. The interaction system 1800 further enables a particular user to invite other users to participate in the play of a specific game by issuing invitations to such other users from the interaction client 1806. The interaction client 1806 also supports audio, video, and text messaging (e.g., chats) within the context of gameplay, provides a leaderboard for the games, and also supports the provision of in-game rewards (e.g., coins and items).

An external resource system 2030 provides an interface for the interaction client 1806 to communicate with remote servers (e.g., third-party servers 1814) to launch or access external resources, i.e., applications or applets. Each third-party server 1814 hosts, for example, a markup language (e.g., HTML5) based application or a small-scale version of an application (e.g., game, utility, payment, or ride-sharing application). The interaction client 1806 may launch a web-based resource (e.g., application) by accessing the HTML5 file from the third-party servers 1814 associated with the web-based resource. Applications hosted by third-party servers 1814 are programmed in JavaScript leveraging a Software Development Kit (SDK) provided by the interaction servers 1822. The SDK includes APIs with functions that can be called or invoked by the web-based application. The interaction servers 1822 host a JavaScript library that provides a given external resource access to specific user data of the interaction client 1806. HTML5 is an example of technology for programming games, but applications and resources programmed based on other technologies can be used.

To integrate the functions of the SDK into the web-based resource, the SDK is downloaded by the third-party server 1814 from the interaction servers 1822 or is otherwise received by the third-party server 1814. Once downloaded or received, the SDK is included as part of the application code of a web-based external resource. The code of the web-based resource can then call or invoke certain functions of the SDK to integrate features of the interaction client 1806 into the web-based resource.

The SDK stored on the interaction server system 1812 effectively provides the bridge between an external resource (e.g., applications 1808 or applets) and the interaction client 1806. This gives the user a seamless experience of communicating with other users on the interaction client 1806 while also preserving the look and feel of the interaction client 1806. To bridge communications between an external resource and an interaction client 1806, the SDK facilitates communication between third-party servers 1814 and the interaction client 1806. A Web ViewJavaScriptBridge running on an XR system 1802 establishes two one-way communication channels between an external resource and the interaction client 1806. Messages are sent between the external resource and the interaction client 1806 via these communication channels asynchronously. Each SDK function invocation is sent as a message and callback. Each SDK function is implemented by constructing a unique callback identifier and sending a message with that callback identifier.

By using the SDK, not all information from the interaction client 1806 is shared with third-party servers 1814. The SDK limits which information is shared based on the needs of the external resource. Each third-party server 1814 provides an HTML5 file corresponding to the web-based external resource to interaction servers 1822. The interaction servers 1822 can add a visual representation (such as a box art or other graphic) of the web-based external resource in the interaction client 1806. Once the user selects the visual representation or instructs the interaction client 1806 through a GUI of the interaction client 1806 to access features of the web-based external resource, the interaction client 1806 obtains the HTML5 file and instantiates the resources to access the features of the web-based external resource.

The interaction client 1806 presents a GUI (e.g., a landing page or title screen) for an external resource. During, before, or after presenting the landing page or title screen, the interaction client 1806 determines whether the launched external resource has been previously authorized to access user data of the interaction client 1806. In response to determining that the launched external resource has been previously authorized to access user data of the interaction client 1806, the interaction client 1806 presents another GUI of the external resource that includes functions and features of the external resource. In response to determining that the launched external resource has not been previously authorized to access user data of the interaction client 1806, after a threshold period of time (e.g., 3 seconds) of displaying the landing page or title screen of the external resource, the interaction client 1806 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 1806 adds the external resource to a list of authorized external resources and allows the external resource to access user data from the interaction client 1806. The external resource is authorized by the interaction client 1806 to access the user data under an OAuth 2 framework.

The interaction client 1806 controls the type of user data that is shared with external resources based on the type of external resource being authorized. For example, external resources that include full-scale applications (e.g., an application 1808) are provided with access to a first type of user data (e.g., 2D avatars of users with or without different avatar characteristics). As another example, external resources that include small-scale versions of applications (e.g., web-based versions of applications) are provided with access to a second type of user data (e.g., payment information, 2D avatars of users, 3D avatars of users, and avatars with various avatar characteristics). Avatar characteristics include different ways to customize a look and feel of an avatar, such as different poses, facial features, clothing, and so forth.

An advertisement system 2032 operationally enables the purchasing of advertisements by third parties for presentation to end-users via the interaction clients 1806 and also handles the delivery and presentation of these advertisements.

### Software Architecture

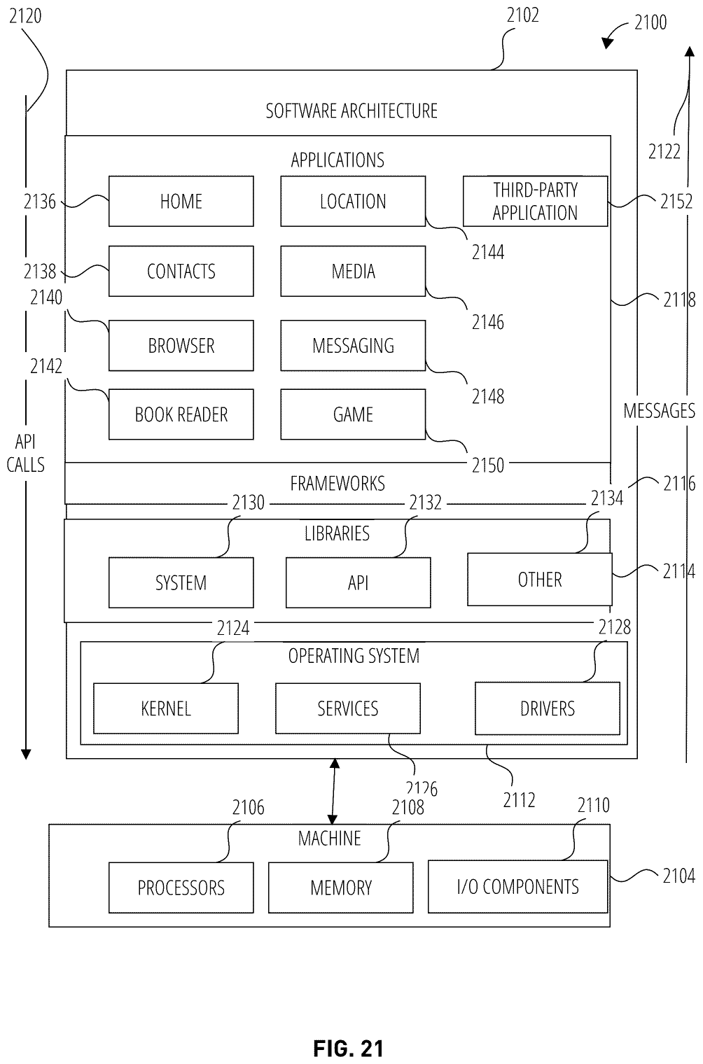

FIG. 21 is a block diagram 2100 illustrating a software architecture 2102, which can be installed on any one or more of the devices described herein. The software architecture 2102 is supported by hardware such as a machine 2104 that includes processors 2106, memory 2108, and I/O components 2110. In this example, the software architecture 2102 can be conceptualized as a stack of layers, where each layer provides a particular functionality. The software architecture 2102 includes layers such as an operating system 2112, libraries 2114, frameworks 2116, and applications 2118. Operationally, the applications 2118 invoke API calls 2120 through the software stack and receive messages 2122 in response to the API calls 2120.

The operating system 2112 manages hardware resources and provides common services. The operating system 2112 includes, for example, a kernel 2124, services 2126, and drivers 2128. The kernel 2124 acts as an abstraction layer between the hardware and the other software layers. For example, the kernel 2124 provides memory management, processor management (e.g., scheduling), component management, networking, and security settings, among other functionalities. The services 2126 can provide other common services for the other software layers. The drivers 2128 are responsible for controlling or interfacing with the underlying hardware. For instance, the drivers 2128 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 2114 provide a common low-level infrastructure used by the applications 2118. The libraries 2114 can include system libraries 2130 (e.g., C standard library) that provide functions such as memory allocation functions, string manipulation functions, mathematic functions, and the like. In addition, the libraries 2114 can include API libraries 2132 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in 2D and 3D in a graphic content on a display), database libraries (e.g., SQLite to provide various relational database functions), web libraries (e.g., WebKit to provide web browsing functionality), and the like. The libraries 2114 can also include a wide variety of other libraries 2134 to provide many other APIs to the applications 2118.

The frameworks 2116 provide a common high-level infrastructure that is used by the applications 2118. For example, the frameworks 2116 provide various GUI functions, high-level resource management, and high-level location services. The frameworks 2116 can provide a broad spectrum of other APIs that can be used by the applications 2118, some of which may be specific to a particular operating system or platform.

In an example, the applications 2118 may include a home application 2136, a contacts application 2138, a browser application 2140, a book reader application 2142, a location application 2144, a media application 2146, a messaging application 2148, a game application 2150, and a broad assortment of other applications such as a third-party application 2152. The applications 2118 are programs that execute functions defined in the programs. Various programming languages can be employed to create one or more of the applications 2118, structured in a variety of manners, such as object-oriented programming languages (e.g., Objective-C, Java, or C++) or procedural programming languages (e.g., C or assembly language). In a specific example, the third-party application 2152 (e.g., an application developed using the ANDROID™ or IOS™ SDK by an entity other than the vendor of the particular platform) may be mobile software running on a mobile operating system such as IOS™, ANDROID™, WINDOWS® Phone, or another mobile operating system. In this example, the third-party application 2152 can invoke the API calls 2120 provided by the operating system 2112 to facilitate functionalities described herein.

### CONCLUSION

Changes and modifications may be made to the disclosed examples without departing from the scope of the present disclosure. These and other changes or modifications are intended to be included within the scope of the present disclosure, as expressed in the following claims.

### Glossary

“Carrier signal” refers to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers to any machine that interfaces to a communications network to obtain resources from one or more server systems or other client devices. Client devices may be, but are not limited to, mobile phones, desktop computers, laptops, PDAs, smartphones, tablets, ultrabooks, netbooks, laptops, multi-processor systems, microprocessor-based or programmable consumer electronics, game consoles, set-top boxes, or any other communication device that a user may use to access a network.

“Communication network” refers to one or more portions of a network that may be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Machine-readable storage medium” refers to both machine-storage media and transmission media. Thus, the terms include both storage devices/media and carrier waves/modulated data signals. The terms “computer-readable medium,” “machine-readable medium” and “device-readable medium” mean the same thing and may be used interchangeably in this disclosure.

“Machine-storage medium” refers to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory machine-readable storage medium” refers to a tangible medium that is capable of storing, encoding, or carrying the instructions for execution by a machine.

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

What is claimed is:

1. A machine-implemented method, comprising:
capturing image data using a camera of an extended Reality (XR) system;
estimating a dark adaptation level of at least one of a user based on the image data;
selecting a night mode rendering configuration based on the estimated dark adaptation level;
generating an XR display using the selected rendering configuration; and
displaying the XR display to the user.

2. The machine-implemented method of claim 1, wherein estimating the dark adaptation level comprises estimating a rod photoreceptor response.

3. The machine-implemented method of claim 1, wherein estimating the dark adaptation level comprises analyzing eye tracking data.

4. The machine-implemented method of claim 1, wherein selecting the rendering configuration comprises selecting peripheral rendering settings and foveal rendering settings.

5. The machine-implemented method of claim 1, wherein the rendering configuration includes a lower spatial resolution in a peripheral region versus the foveal region.

6. The machine-implemented method of claim 1, wherein the rendering configuration includes a lower temporal resolution in a peripheral region versus a foveal region.

7. The machine-implemented method of claim 1, wherein the rendering configuration includes longer wavelength light in a peripheral region versus a foveal region.

8. A machine comprising:
one or more processors; and
memory storing instructions that, when executed by the one or more processors, cause the machine to perform operations comprising:
capturing image data using a camera of an extended Reality (XR) system;
estimating a dark adaptation level of at least one of a user based on the image data;
selecting a night mode rendering configuration based on the estimated dark adaptation level;
generating an XR display using the selected rendering configuration; and
displaying the XR display to the user.

9. The machine of claim 8, wherein estimating the dark adaptation level comprises estimating a rod photoreceptor response.

10. The machine of claim 8, wherein estimating the dark adaptation level comprises analyzing eye tracking data.

11. The machine of claim 8, wherein selecting the rendering configuration comprises selecting peripheral rendering settings and foveal rendering settings.

12. The machine of claim 8, wherein the rendering configuration includes a lower spatial resolution in a peripheral region versus the foveal region.

13. The machine of claim 8, wherein the rendering configuration includes a lower temporal resolution in a peripheral region versus a foveal region.

14. The machine of claim 8, wherein the rendering configuration includes longer wavelength light in a peripheral region versus a foveal region.

15. A machine-storage medium including instructions that, when executed by a machine, cause the machine to perform operations comprising:
capturing image data using a camera of an extended Reality (XR) system;
estimating a dark adaptation level of at least one of a user based on the image data;
selecting a night mode rendering configuration based on the estimated dark adaptation level;
generating an XR display using the selected rendering configuration; and
displaying the XR display to the user.

16. The machine-storage medium of claim 15, wherein estimating the dark adaptation level comprises estimating a rod photoreceptor response.

17. The machine-storage medium of claim 15, wherein estimating the dark adaptation level comprises analyzing eye tracking data.

18. The machine-storage medium of claim 15, wherein selecting the rendering configuration comprises selecting peripheral rendering settings and foveal rendering settings.

19. The machine-storage medium of claim 15, wherein the rendering configuration includes a lower spatial resolution in a peripheral region versus the foveal region.

20. The machine-storage medium of claim 15, wherein the rendering configuration includes a lower temporal resolution in a peripheral region versus a foveal region.
